(19) United States
(12) Patent Application Publication
(10) Pub. No.: US 2026/0369774 A1
(43) Pub. Date: Nov. 19, 2026

(54) BATTERY APPARATUS AND ELECTRIC DEVICE

(71) Applicant: CONTEMPORARY AMPEREX TECHNOLOGY CO., LIMITED, Ningde (CN)

(72) Inventors: Jun MA, Ningde (CN); Cancan LI, Ningde (CN); Jiangming LIU, Ningde (CN)

(21) Appl. No.: 19/343,489

(22) Filed: Sep. 29, 2025

Related U.S. Application Data
(63) Continuation of application No. PCT/CN2025/104426, filed on Jun. 27, 2025.

(30) Foreign Application Priority Data
May 16, 2025 (CN) 202510637451.4

(51) Int. Cl. H01M 50/242; H01M 10/617; H01M 10/625; H01M 10/6557; H01M 50/249; H01M 50/264; H01M 50/289; H01M 50/204

(52) U.S. Cl. CPC H01M 50/242; H01M 10/617; H01M 10/625; H01M 10/6557; H01M 50/249; H01M 50/264; H01M 50/289; H01M 50/204

(57) ABSTRACT

A battery apparatus and an electric device. The battery apparatus of the present application includes a battery cell assembly and a box. The battery cell assembly includes a plurality of battery cells arranged along a first direction; the box includes a first box body and a second box body, the first box body and the second box body buckle each other and jointly define an accommodation space, the battery cell assembly is located in the accommodation space, the first box body includes a frame and a plurality of structural beams, the structural beams are located at the bottom of the frame and connected to the frame, the plurality of structural beams are spaced apart along a second direction, the first direction and the second direction intersect, and a plane where the first direction and the second direction are jointly located intersects a height direction of the box.

### CROSS-REFERENCE TO RELATED APPLICATIONS

The present application is a continuation of International Application No. PCT/CN2025/104426, filed on Jun. 27, 2025, which claims priority to Chinese Patent Application No. 202510637451.4, filed on May 16, 2025, and entitled "BATTERY APPARATUS AND ELECTRIC DEVICE", the entire contents of both of which are incorporated herein by reference.

### TECHNICAL FIELD

The present application relates to the field of battery technology, and in particular, to a battery apparatus and an electric device.

### BACKGROUND

In the field of battery applications, the box of the battery apparatus plays a crucial role. As a key component for accommodating battery cells, it is widely used in scenarios such as electric vehicles, energy storage power stations, and various portable electronic devices. The box must have certain strength and stiffness, to stably fix the battery cells, so that during the operation of the device, the battery cells will not be displaced or damaged due to external force factors such as vibration or collision, and reliable protection is provided for the battery cells to prevent them from being interfered by external environmental factors such as moisture, dust, mechanical impact, thereby ensuring the normal operation of the battery apparatus as well as the safety and service life of the battery cells.

However, in the current process of box design and manufacturing, there exists a prominent problem, that is, the weight of the box is generally large. This increases the material cost of the battery apparatus, and the cruising range of the vehicle is reduced due to the excessive weight of the box applied to new energy vehicles.

### SUMMARY

In view of the above problems, the present application provides a battery apparatus and an electric device, in which a plurality of structural beams are spaced apart along a second direction, which can reduce the weight of the box of the battery apparatus to save material costs.

According to a first aspect, the present application provides a battery apparatus, including:
a battery cell assembly, including a plurality of battery cells arranged along a first direction; and
a box, including a first box body and a second box body, where the first box body and the second box body jointly define an accommodation space, the battery cell assembly is located in the accommodation space, the first box body includes a frame and a plurality of structural beams, the structural beams are located at the bottom of the frame and connected to the frame, the plurality of structural beams are spaced apart along a second direction, the first direction and the second direction intersect, and a plane where the first direction and the second direction are jointly located intersects a height direction of the box.

Spacing apart the plurality of structural beams, compared with using a water-cooling plate placed on the largest surface of the cell for the conventional box, can reduce the weight of the box, thereby saving material costs.

In some embodiments, the battery cell is connected to the structural beam.

The battery cell is connected to the structural beam, which can increase the natural frequency of the battery apparatus, and in the case of vibration or swelling, can reduce the possibility of electrical connection failure of components inside the battery apparatus to improve the reliability of the operation of the battery apparatus.

In some embodiments, the battery cell is bonded to the structural beam.

The battery cell is bonded to the structural beam, which can increase the natural frequency (a fixed frequency) of the battery apparatus, so that in occasions with vibration impact or when the battery cell swells, the possibility of electrical connection failure of components inside the battery apparatus is reduced, thereby improving the reliability of the operation of the battery apparatus. This bonding, compared with the large-area glue filling at the bottom of the conventional box, can reduce the usage amount of structural glue, which is conducive to reducing the weight of the battery apparatus and lowering the manufacturing cost.

In some embodiments, a same battery cell is bonded to the plurality of structural beams.

By jointly supporting the same battery cell with the plurality of structural beams, the stress generated by the charging and discharging swelling of the battery or the external vibration impact force can be evenly distributed to the plurality of structural beams, reducing the excessive deformation of the structural beams caused by local stress concentration. The integrated structure formed by bonding the plurality of structural beams can significantly increase the natural frequency of the battery apparatus, and suppress the displacement of the battery cell caused by vibration or the fatigue failure of electrical connection components such as tabs, which is conducive to improving the stability of the battery apparatus.

In some embodiments, along the height direction of the box, an orthographic projection area of a single structural beam on the same battery cell is S1, and an area of a surface of the battery cell facing one side of the structural beam is S2.

The structural beam is a solid beam, and a value range of S2/S1 is 1.4–5; or the structural beam is a hollow beam, and a value range of S2/S1 is 1.4–2.5.

The value range of S2/S1 is limited to the above range, the box is not too heavy, and on the premise of satisfying the support strength of the structural beam, the natural frequency of the battery apparatus is not too low, so that in occasions with vibration impact or when the battery cell swells, the possibility of electrical connection failure of components inside the battery apparatus is reduced, thereby improving the reliability of the operation of the battery apparatus.

In some embodiments, when the structural beam is a solid beam, the value range of S2/S1 is 1.6–3.3; or when the structural beam is a hollow beam, the value range of S2/S1 is 1.6–2.

The value range of S2/S1 is limited to the above range, which can further balance the requirements of weight and support strength, so that the natural frequency of the battery apparatus is not too low.

In some embodiments, along the height direction of the box, a size of an orthographic projection of each structural beam on the same battery cell along the second direction is L1, and a size of the battery cell along the second direction is L2.

The structural beam is a solid beam, and a value range of L1/L2 is 0.2–0.7; or the structural beam is a hollow beam, and a value range of L1/L2 is 0.4–0.7.

The value range of L1/L2 is limited to the above range, which can not only make the battery cell have sufficient contact area with the structural beam to disperse stress, but also reduce the situation where the weight of the box increases due to excessive size.

In some embodiments, when the structural beam is a solid beam, the value range of L1/L2 is 0.3–0.6; or when the structural beam is a hollow beam, the value range of L1/L2 is 0.5–0.6.

The value range of L1/L2 is limited to the above range, further optimizing the value range, which can not only make the battery cell have sufficient contact area with the structural beam to disperse stress, but also reduce the situation where the weight of the box increases due to excessive size.

In some embodiments, the same battery cell is bonded to two adjacent structural beams.

This bonding, compared with support for the battery cell by one structural beam, can reduce the load on the structural beam to reduce the deformation of the structural beam, and in occasions with vibration impact or when the battery cell swells, reduce the possibility of electrical connection failure of components inside the battery apparatus, thereby improving the reliability of the operation of the battery apparatus.

In some embodiments, a plurality of battery cell assemblies are provided, the plurality of battery cell assemblies are arranged along the second direction, and two adjacent battery cell assemblies are bonded to a same structural beam.

The same structural beam can support two adjacent battery cell assemblies, so that the plurality of battery cell assemblies are bonded to the plurality of structural beams through structural glue to form an integrated structure, which is conducive to increasing the natural frequency of the battery apparatus, and in occasions with vibration impact or when the battery cell swells, the possibility of electrical connection failure of components inside the battery apparatus is reduced, thereby improving the reliability of the operation of the battery apparatus. In addition, two adjacent battery cell assemblies are jointly supported by one structural beam, which can reduce the number of the structural beams used, and is conducive to reducing the weight of the box of the battery apparatus.

In some embodiments, along the height direction of the box, an orthographic projection area of a single structural beam on the same battery cell is S1, and an area of a surface of the battery cell facing one side of the structural beam is S2.

The structural beam is a solid beam, and the value range of S2/S1 is 2.8–10; or the structural beam is a hollow beam, and the value range of S2/S1 is 2.8–5.

The value range of S2/S1 is limited to the above range, the box is not too heavy, and on the premise of satisfying the support strength of the structural beam, the natural frequency of the battery apparatus is not too low, so that in occasions with vibration impact or when the battery cell swells, the possibility of electrical connection failure of components inside the battery apparatus is reduced, thereby improving the reliability of the operation of the battery apparatus.

In some embodiments, when the structural beam is a solid beam, the value range of S2/S1 is 3.3–6.6; or when the structural beam is a hollow beam, the value range of S2/S1 is 3.3–4.

The value range of S2/S1 is limited to the above range, which can further balance the requirements of weight and support strength, so that the natural frequency of the battery apparatus is not too low.

In some embodiments, along the height direction of the box, a size of an orthographic projection of each structural beam on the same battery cell along the second direction is L1, and a size of the battery cell along the second direction is L2.

The structural beam is a solid beam, and a value range of L1/L2 is 0.1–0.35; or the structural beam is a hollow beam, and a value range of L1/L2 is 0.2–0.35.

The value range of L1/L2 is limited to the above range, which can not only make the battery cell have sufficient contact area with the structural beam to disperse stress, but also reduce the situation where the weight of the box increases due to excessive size.

In some embodiments, when the structural beam is a solid beam, the value range of L1/L2 is 0.15–0.3; or when the structural beam is a hollow beam, the value range of L1/L2 is 0.25–0.3.

The value range of L1/L2 is limited to the above range, further optimizing the value range, which can not only make the battery cell have sufficient contact area with the structural beam to disperse stress, but also reduce the situation where the weight of the box increases due to excessive size.

In some embodiments, the battery apparatus further includes a thermal management component, the thermal management component is located on a side of the battery cell away from the second box body, the thermal management component is provided between two adjacent structural beams, and the thermal management component has a heat exchange channel inside.

As a result, the temperature of each battery cell can be adjusted through the thermal management component, so that each battery cell can fully exert its own performance during operation, to reduce the impact of excessively high or low temperature on the performance of the battery cell.

In some embodiments, a size of the structural beam along the second direction is W, the structural beam is a solid beam, and a value range of W is 20 mm–700 mm; or the structural beam is a hollow beam, and a value range of W is 40 mm–700 mm.

For the solid beam or the hollow beam, the smaller lower limit can meet the support requirements of low-load scenarios while reducing material consumption, and the upper limit of 700 mm provides redundancy for high-load requirements. The wide beam can enhance the anti-vibration capability. For example, if the length and weight of a blade battery are relatively large, it can be supported by a relatively wide structural beam to maintain the stability of the overall structure of the battery apparatus.

In some embodiments, the structural beam is a flat beam, and a thickness direction of the structural beam is the same as the height direction of the box.

On the premise of not changing the total height of the box, the flat beam does not occupy too much space at the bottom of the box, so as to accommodate battery cells with larger volume. On the premise of not changing the width of the structural beam, the flat beam can reduce the weight of the box and save more materials.

In some embodiments, the structural beam is a solid beam, and along the height direction of the box, a size of the structural beam is h1, and a value range of h1 is 3 mm–8 mm;

or, the structural beam is a hollow beam, and along the height direction of the box, a size of a cavity of the structural beam is h2, a wall thickness of the structural beam is s, a value range of h2 is 4.4 mm–8 mm, and a value range of s is 1.8 mm–3 mm.

As a result, on the premise of not changing the total height of the box, it does not occupy too much space at the bottom of the box, so as to accommodate battery cells with larger volume. On the premise of not changing the width of the structural beam, the weight of the box can be reduced, and more materials can be saved.

In some embodiments, the structural beam has a heat exchange flow channel inside as well as an inlet and an outlet both communicating with the heat exchange flow channel, and the heat exchange flow channel extends along the first direction.

As the structural beam is provided with a heat exchange flow channel inside, the weight of the box can be further reduced, and by introducing a heat exchange medium into the heat exchange flow channel, the temperature of the battery cell during operation can be adjusted, so that the battery apparatus can operate in a suitable temperature range to fully exert the performance of the battery apparatus. In addition, the provision of the heat exchange flow channel in the structural beam can reduce the manufacturing difficulty compared with the use of a water-cooling plate for the conventional battery apparatus.

In some embodiments, the battery apparatus further includes a thermal management component, and along the first direction, the thermal management component is provided between two adjacent battery cells, and the thermal management component has a heat exchange channel inside.

As a result, the temperature of each battery cell can be adjusted through the thermal management component, so that each battery cell can fully exert its own performance during operation, to reduce the impact of excessively high or low temperature on the performance of the battery cell.

In some embodiments, the frame includes two first side beams spaced apart along the second direction, two outermost structural beams along the second direction are first structural beams, and the first structural beams are connected to the first side beams.

The first side beams serve as lateral boundary supports of the frame, which can increase the overall stiffness of the first box body and reduce the risk of local deformation caused by uneven force. In occasions with vibration impact or when the battery cell swells, the possibility of electrical connection failure of components inside the battery apparatus can be reduced, thereby improving the reliability of the operation of the battery apparatus.

In some embodiments, the first structural beam is integrally formed with the first side beam.

As a result, the overall stiffness of the box can be further improved, and the integral formation can be achieved by a simplified connection method, which improves the assembly efficiency compared with other connection methods such as fasteners between the first structural beam and the first side beam.

In some embodiments, the first box body further includes a spacer beam, a length direction of the spacer beam is the same as the second direction, battery cell assemblies are respectively provided on both sides of the spacer beam along the first direction, and the spacer beam is respectively connected to at least one of the structural beam and the frame.

The provision of the spacer beam can further improve the bending resistance of the plurality of structural beams to increase the natural frequency of the battery apparatus, so that in occasions with vibration impact or when the battery cell swells, the possibility of electrical connection failure of components inside the battery apparatus is reduced, thereby improving the reliability of the operation of the battery apparatus.

In some embodiments, the structural beam has a through hole, the through hole runs through both sides of the structural beam along the height direction of the box, the first box body further includes a locking member, and one end of the locking member passes through the through hole and is connected to the spacer beam.

As a result, the fixation of the plurality of structural beams and the spacer beam can be achieved to increase the bearing capacity of the structural beams, which is conducive to increasing the natural frequency of the battery apparatus.

In some embodiments, the structural beam has a cavity inside, and the through hole is provided in a side wall of one side of the cavity along the second direction.

On the premise of satisfying the natural frequency of the battery apparatus, configuring the structural beam as a cavity structure can reduce the weight of the box and save material costs. In addition, the cavity can also be used as a heat exchange channel to adjust the temperature of the battery cell during operation.

In some embodiments, a plurality of cavities are provided, the plurality of cavities are spaced apart along the second direction, and the side wall is formed between at least part of two adjacent cavities.

As a result, the weight of the box can be further reduced.

In some embodiments, along the height direction of the box, a size of an orthographic projection of the locking member on the structural beam along the second direction is less than or equal to a size of the side wall along the second direction.

As a result, after the locking member is locked, the possibility of the cavity being crushed due to excessive pressure of the locking member can be reduced to meet the support stiffness and lightweight requirements of the structural beam.

In some embodiments, one side of the battery cell facing the second box body is provided with an electrode terminal.

This is convenient for the electrical connection between the electrode terminals of the battery cell and the electrode terminals of other battery cells.

In some embodiments, one side of the battery cell facing the second box body is provided with a pressure relief mechanism, and the pressure relief mechanism is configured to actuate when the battery cell is in thermal runaway and an internal pressure of the battery cell reaches a set value, to release emissions.

The pressure relief mechanism can effectively reduce the risk of internal pressure accumulation in the battery cell and improve the safety of the battery apparatus.

In some embodiments, the first box body further includes a protective plate, and the protective plate is located on a side of the first box body away from the second box body and connected to the first box body.

The provision of the protective plate can protect the side of the first box body away from the second box body. Especially when the battery apparatus is applied to new energy vehicles, the protective plate can absorb external impact and collision.

In some embodiments, along the height direction of the box, there is a gap between the protective plate and the structural beam, the first box body further includes a buffer member, and the buffer member is provided in the gap.

Providing the buffer member between the protective plate and the first box body can buffer the impact from the outside to improve the protection of the battery cell, thereby improving the reliability of the operation of the battery cell.

In some embodiments, the first box body further includes a sealing member, the sealing member is arranged around the accommodation space, and the sealing member is sandwiched between the protective plate and the frame.

The sealing member can prevent external dust, water, and the like from entering the battery apparatus to protect the components inside the battery apparatus.

In some embodiments, the first box body is located below the second box body. The battery cell is connected to both the structural beam and the second box body, and the electrode terminal of the battery cell is disposed upside down in the box. The resulting structure, compared with a structure where the electrode terminal is disposed upright in the box, can improve the space utilization rate of the box.

In some embodiments, the frame includes two second side beams spaced apart along the first direction, the structural beams are connected to the second side beams, the second side beams are configured to be connected to a vehicle, and the first direction is configured to intersect a traveling direction of the vehicle.

The second side beams are configured to be connected to the vehicle, and the second side beams are used as mounting beams. Since the mounting beams have the characteristics of high strength and impact resistance, they can resist the swelling force of the battery cells along the first direction to reduce the deformation of the frame. The structure formed by the second side beams, compared with the structure where an arrangement direction of the plurality of battery cells of the same battery cell assembly is the same as the traveling direction of the vehicle, can reduce the deformation of the frame without increasing the weight and strength of the side beams of the frame along the first direction, which is conducive to reducing the weight of the first box body.

According to a second aspect, the present application provides an electric device, including the battery apparatus according to the first aspect, where the battery apparatus is configured to provide electrical energy to the electric device.

Since the electric device includes all the technical features of the battery apparatus in the first aspect, the effects are the same as described above and will not be elaborated here.

The above description is only an overview of the technical solutions of the present application. In order to more clearly understand the technical means of the present application so that they can be implemented in accordance with the contents of the description, and in order to make the above and other purposes, features, and advantages of the present application more obvious and understandable, the specific embodiments of the present application are given below.

### BRIEF DESCRIPTION OF THE DRAWINGS

By reading the detailed description of the embodiments below, various other advantages and benefits will become clear to those of ordinary skill in the art. The drawings are only used for the purpose of illustrating some embodiments and are not considered to limit the present application. Moreover, in all the drawings, the same reference numerals denote the same components. In the drawings:

FIG. 1 is an exploded view of a battery apparatus according to some embodiments of the present application;

FIG. 2 is a top view of a battery apparatus according to some embodiments of the present application, with a second box body omitted;

FIG. 3 is a partial cross-sectional view along A–A of FIG. 2;

FIG. 4 is an exploded view of a battery apparatus according to some embodiments of the present application;

FIG. 5 is a top view of a battery apparatus according to some embodiments of the present application, with a second box body omitted;

FIGS. 6–8 are partial cross-sectional views along B-B of different embodiments of the battery apparatus in FIG. 5;

FIG. 9 is a structural diagram of one embodiment of a structural beam in a battery apparatus according to some embodiments of the present application;

FIG. 10 is an exploded view of a battery apparatus according to some embodiments of the present application, with a second box body omitted;

FIG. 11 is an isometric view of one embodiment of a first box body of the battery apparatus in FIG. 10;

FIG. 12 is a top view of a battery apparatus according to some embodiments of the present application, with a second box body omitted;

FIG. 13 is a partial cross-sectional view along C–C of FIG. 12;

FIG. 14 is a partial enlarged view at portion I of FIG. 13;

FIG. 15 is a top view of a battery apparatus according to some embodiments of the present application, with a second box body omitted;

FIG. 16 is a top view of one embodiment of a first box body in a battery apparatus according to some embodiments of the present application;

FIG. 17 is an isometric view of one embodiment of a battery cell in a battery apparatus according to some embodiments of the present application;

FIG. 18 is a structural diagram of one embodiment of a first box body in a battery apparatus according to some embodiments of the present application;

FIG. 19 is a cross-sectional view along D–D of FIG. 18;

FIG. 20 is a partial exploded view of Embodiment 1 of a first box body in a battery apparatus according to some embodiments of the present application;

FIG. 21 is a cross-sectional view along E–E of FIG. 18;

FIG. 22 is a partial exploded view of Embodiment 2 of a first box body in a battery apparatus according to some embodiments of the present application;

FIGS. 23–25 are structural diagrams of different embodiments of a first box body in a battery apparatus according to some embodiments of the present application, where arrows indicate a flow direction of a heat exchange flow path;

FIG. 26 is a structural diagram of Embodiment 3 of a first box body in a battery apparatus according to some embodiments of the present application;

FIG. 27 is a cross-sectional view along F–F of FIG. 26; and

FIG. 28 is a structural diagram of an electric device being a vehicle according to some embodiments of the present application.

Reference numerals in the description of embodiments are as follows:
1000. vehicle; 100. battery apparatus; 200. controller; 300. motor;
110. battery cell assembly; 120. box; 121. first box body; 1211. frame; 12111. first side beam; 121111. first abutting surface; 12112. second side beam; 121121. mounting hole; 1212. structural beam; 12121. heat exchange flow channel; 12122. through hole; 12123. cavity; 12124. first interface; 12125. second interface; 1213. spacer beam; 1214. protective plate; 1215. buffer member; 1216. sealing member; 1217. locking member; 1218. current collector component; 12181. current collector unit; 121811. plug-in portion; 121812. body portion; 121813. tube portion; 1218121. current collector channel; 1218122. support rib; 12182. connecting portion; 121821. protrusion; 1219. connecting tube; 122. second box body; 130. thermal management component;
111. battery cell; 1111. pressure relief mechanism; 1112. electrode terminal;
X. first direction; Y. second direction; and Z. height direction.

### DETAILED DESCRIPTION

The embodiments of the technical solutions of the present application will be described in detail below in conjunction with the drawings. The following embodiments are only used to more clearly illustrate the technical solutions of the present application, and therefore are only examples and do not limit the protection scope of the present application.

Unless otherwise specified, all technical and scientific terms used herein have the same meaning as commonly understood by those skilled in the technical field of the present application; the terms used herein are only for the purpose of describing specific embodiments and are not intended to limit the present application; and the terms "include" and "have" in the description, claims, and the above description of the drawings of the present application and any variations thereof are intended to cover non-exclusive inclusions.

In the description of the embodiments of the present application, the technical terms "first", "second", and the like are only used to distinguish different objects and should not be understood as indicating or implying relative importance or implicitly indicating the number, specific order, or primary-secondary relationship of the indicated technical features. In the description of the embodiments of the present application, "a plurality of" means two or more, unless otherwise explicitly and specifically defined.

Reference herein to "embodiment" means that a particular feature, structure, or characteristic described in connection with the embodiment may be included in at least one embodiment of the present application. The appearance of this phrase in various places in the description does not necessarily refer to the same embodiment, nor is it an independent or alternative embodiment mutually exclusive with other embodiments. Those skilled in the art explicitly and implicitly understand that the embodiments described herein can be combined with other embodiments.

In the description of the embodiments of the present application, the term "and/or" is only an association relationship describing associated objects, indicating that three relationships may exist. For example, A and/or B can mean: A exists alone, A and B exist at the same time, and B exists alone. In addition, the character "/" herein generally indicates that the associated objects before and after are in an "or" relationship. In this disclosure, unless otherwise specified, phrases like “at least one of A, B, and C” and “at least one of A, B, or C” both mean only A, only B, only C, or any combination of A, B, and C.

In the description of the embodiments of the present application, the term "a plurality of" refers to two or more (including two), and similarly, "a plurality of groups" refers to two or more (including two) groups, and "a plurality of pieces" refers to two or more (including two) pieces.

In the description of the embodiments of the present application, the orientation or positional relationships indicated by the technical terms "center", "longitudinal", "lateral", "length", "width", "thickness", "upper", "lower", "front", "rear", "left", "right", "vertical", "horizontal", "top", "bottom", "inner", "outer", "clockwise", "counterclockwise", "axial", "radial", "circumferential", and the like are based on the orientation or positional relationships shown in the drawings, and are only for the convenience of describing the embodiments of the present application and simplifying the description, rather than indicating or implying that the referred apparatus or element must have a specific orientation, be constructed and operated in a specific orientation, and therefore should not be understood as limiting the embodiments of the present application.

In the description of the embodiments of the present application, unless otherwise explicitly specified and limited, the technical terms "mount", "connect", "join", "fix", and the like should be understood in a broad sense. For example, it may be a fixed connection, a detachable connection, or an integral connection; it may be a mechanical connection or an electrical connection; it may be a direct connection or an indirect connection through an intermediate medium; or it may be the internal communication of two elements or the interaction relationship between two elements. For those of ordinary skill in the art, the specific meanings of the above terms in the embodiments of the present application may be understood according to specific circumstances.

The bottom wall of the box of existing battery apparatuses is typically a panel placed on the largest surface of the cell, which is connected to the frame. The bottom wall is generally composed of a water-cooling plate with complex internal flow channels. The welding process between the water-cooling plate and the frame is complex, and the bottom wall formed by the water-cooling plate increases the overall weight of the box. Excessive box weight increases the material cost of the battery apparatus, and the cruising range of the vehicle is reduced due to the excessive weight applied to new energy vehicles.

In view of this, the present application provides a battery apparatus in which a plurality of structural beams are spaced apart to replace the conventional bottom plate or water-cooling plate placed on the largest surface of the cell, thereby reducing the weight of the box to save material costs while eliminating the complex internal flow channel structure of the water-cooling plate, making the box structure simpler.

The battery apparatus (Battery Apparatus) mentioned in the embodiments of the present application may include one or more battery cell assemblies for providing voltage and capacity. The battery cell assembly (Battery Cell Assembly) may include a plurality of battery cells, and the plurality of battery cells are connected in series, parallel, or a combination thereof through a bus component.

In some embodiments, the battery cell assembly (Battery Cell Assembly) is typically formed by arranging a plurality of battery cells.

As an example, the battery cell assembly may be a battery module (Battery Module), where the battery module is formed by arranging and fixing a plurality of battery cells into an independent module. As an example, the battery module may be formed by bundling a plurality of battery cells with straps.

In some embodiments, the battery apparatus may be a battery pack (Battery Pack), where the battery pack includes a box and one or more battery cell assemblies, and the battery cell assemblies are accommodated in the box.

As an example, the battery cell assembly may be a battery module, and the battery cell assembly may be accommodated in the box by fixing the battery module in the box.

As an example, the battery cell assembly may also be accommodated in the box by directly fixing a plurality of battery cells in the box.

As an example, the box may include a first box body and a second box body. The first box body and the second box body buckle together to accommodate the battery cell assembly.

As an example, the box may include a top cover, a frame, and a bottom plate. The top cover and the bottom plate are both connected to the frame, forming a closed space inside the box to accommodate the battery cell assembly.

In some embodiments, the box may serve as part of the chassis structure of a vehicle. For example, a portion of the box may form at least part of the floor of the vehicle, or a portion of the box may form at least part of the cross beams and longitudinal beams of the vehicle.

The technical solutions described in the embodiments of the present application are applicable to various electric devices using battery apparatuses, such as electric scooters, vehicles, ships, and spacecraft, where spacecraft include airplanes, rockets, space shuttles, spaceships, and the like.

In some embodiments, the battery cell may be a secondary battery, which refers to a battery cell that can be charged after discharge of the battery cell to reactivate the active material for continued use.

The battery cell may be a lithium-ion battery, a sodium-ion battery, a sodium-lithium-ion battery, a lithium metal battery, a sodium metal battery, a lithium-sulfur battery, a magnesium-ion battery, a nickel-hydrogen battery, a nickel-cadmium battery, a lead-acid battery, and the like, and the embodiments of the present application are not limited thereto.

The battery cell generally includes an electrode assembly. The electrode assembly includes a positive electrode, a negative electrode, and a separator, where the separator is provided between the negative electrode and the positive electrode. During the charging and discharging process of the battery cell, active ions, such as lithium ions, intercalate and deintercalate back and forth between the positive electrode and the negative electrode. The separator is provided between the positive electrode and the negative electrode to prevent short-circuiting between the positive and negative electrodes while allowing active ions to pass through.

In some embodiments, the positive electrode may be a positive electrode plate, and the positive electrode plate may include a positive electrode current collector and a positive electrode active material disposed on at least one surface of the positive electrode current collector.

As an example, the positive electrode current collector has two opposing surfaces in its thickness direction, and the positive electrode active material is disposed on either or both of the two opposing surfaces of the positive electrode current collector.

As an example, the positive electrode current collector may use metal foil, conductive polymer material, carbon material, or composite current collector. For example, as a metal foil, it may use pure metal, alloy, or surface-treated metal, including but not limited to stainless steel, copper, aluminum, nickel, titanium, and silver. The composite current collector may include a polymer material fiber layer and a metal layer. The composite current collector may be formed by depositing metal materials such as aluminum, aluminum alloy, nickel, nickel alloy, titanium, titanium alloy, silver, and silver alloy on a polymer material substrate such as polypropylene, polyethylene terephthalate, polybutylene terephthalate, polystyrene, or polyethylene.

As an example, the positive electrode active material may include at least one of the following materials: lithium-containing phosphate, lithium transition metal oxide, and their respective modified compounds. However, the present application is not limited to these materials, and other conventional materials that can be used as positive electrode active materials for batteries may also be used. These positive electrode active materials may be used alone or in combination of two or more. Examples of lithium-containing phosphates may include, but are not limited to, at least one of lithium iron phosphate (for example, LiFePO₄, also abbreviated as LFP), a composite material of lithium iron phosphate and carbon, lithium manganese phosphate (for example, LiMnPO₄), a composite material of lithium manganese phosphate and carbon, lithium iron manganese phosphate, and a composite material of lithium iron manganese phosphate and carbon. Examples of lithium transition metal oxides may include, but are not limited to, at least one of lithium cobalt oxide (for example, LiCoO₂), lithium nickel oxide (for example, LiNiO₂), lithium manganese oxide (for example, LiMnO₂, LiMn₂O₄), lithium nickel cobalt oxide, lithium manganese cobalt oxide, lithium nickel manganese oxide, lithium nickel cobalt manganese oxide (for example, LiNi1/3Co1/3Mn1/3O₂, also abbreviated as NCM333; LiNi0.5Co0.2Mn0.3O₂, also abbreviated as NCM523; LiNi0.5Co0.25Mn0.25O₂, also abbreviated as NCM211; LiNi0.6Co0.2Mn0.2O₂, also abbreviated as NCM622; LiNi0.8Co0.1Mn0.1O₂, also abbreviated as NCM811), lithium nickel cobalt aluminum oxide (for example, LiNi0.8Co0.15Al0.05O₂), and their modified compounds. Modified compounds refer to substances obtained by modification techniques such as doping or coating based on the above materials.

In some embodiments, the positive electrode may use foam metal. The foam metal may be foam nickel, foam copper, foam aluminum, foam alloy, foam carbon, or the like. When foam metal is used as the positive electrode, the surface of the foam metal may not be provided with a positive electrode active material. Certainly, it may also be provided with a positive electrode active material. As an example, the positive electrode active material is filled and/or deposited within the foam metal.

In some embodiments, the negative electrode may be a negative electrode plate, and the negative electrode plate may include a negative electrode current collector.

As an example, the negative electrode current collector may use metal foil, conductive polymer material, carbon material, or composite current collector. For example, as a metal foil, it may use pure metal, alloy, or surface-treated metal, including but not limited to stainless steel, copper, aluminum, nickel, titanium, and silver. The composite current collector may include a polymer material fiber layer and a metal layer. The composite current collector may be formed by depositing metal materials (copper, copper alloy, nickel, nickel alloy, titanium, titanium alloy, silver, silver alloy, or the like) on a polymer material substrate (for example, polypropylene, polyethylene terephthalate, polybutylene terephthalate, polystyrene, or polyethylene).

As an example, the negative electrode plate may include a negative electrode current collector and a negative electrode active material disposed on at least one surface of the negative electrode current collector.

As an example, the negative electrode current collector has two opposing surfaces in its thickness direction, and the negative electrode active material is disposed on either or both of the two opposing surfaces of the negative electrode current collector.

As an example, the negative electrode active material may use negative electrode active materials known in the art for battery cells. As an example, the negative electrode active material may include at least one of the following materials: artificial graphite, natural graphite, soft carbon, hard carbon, silicon-based material, tin-based material, and lithium titanate. The silicon-based material may be selected from at least one of elemental silicon, silicon oxide compound, silicon-carbon composite, silicon-nitrogen composite, and silicon alloy. The tin-based material may be selected from at least one of elemental tin, tin oxide compound, and tin alloy. However, the present application is not limited to these materials, and other conventional materials that can be used as negative electrode active materials for battery cells may also be used. These negative electrode active materials may be used alone or in combination of two or more.

In some embodiments, the negative electrode may use foam metal. The foam metal may be foam nickel, foam copper, foam aluminum, foam alloy, foam carbon, or the like. When foam metal is used as the negative electrode plate, the surface of the foam metal may not be provided with a negative electrode active material. Certainly, it may also be provided with a negative electrode active material.

As an example, the negative electrode active material may be filled and/or deposited within the negative electrode current collector.

In some embodiments, the material of the positive electrode current collector may be aluminum, and the material of the negative electrode current collector may be copper.

In some embodiments, the electrode assembly further includes a separator, and the separator is provided between the positive electrode and the negative electrode.

In some embodiments, the separator is a separating film. The present application has no particular restrictions on the type of separating film, and any well-known porous structure separating film with good chemical stability and mechanical stability may be selected.

As an example, the main material of the separating film may be selected from at least one of glass fiber, non-woven fabric, polyethylene, polypropylene, polyvinylidene fluoride, or ceramic. The separating film may be a single-layer film or a multilayer composite film, with no particular restrictions. When the separating film is a multilayer composite film, the materials of various layers may be the same or different, with no particular restrictions. The separator may be a separate component located between the positive and negative electrodes or may be attached to the surface of the positive and negative electrodes. The surface of the separating film may also be coated with an inorganic particle coating, an organic particle coating, or an organic/inorganic composite coating.

In some embodiments, the separator is a solid-state electrolyte. The solid-state electrolyte is provided between the positive electrode and the negative electrode, serving both to conduct ions and to isolate the positive and negative electrodes.

In some embodiments, the battery cell further includes an electrolyte, which conducts ions between the positive and negative electrodes. The present application has no specific restrictions on the type of electrolyte, which may be selected according to requirements. The electrolyte may be liquid, gel, or solid.

The liquid electrolyte includes electrolyte salt and a solvent.

In some embodiments, the electrolyte salt may be selected from at least one of lithium hexafluorophosphate, lithium tetrafluoroborate, lithium perchlorate, lithium hexafluoroarsenate, lithium bis(fluorosulfonyl)imide, lithium bis(trifluoromethanesulfonyl)imide, lithium trifluoromethanesulfonate, lithium difluorophosphate, lithium difluoro(oxalato)borate, lithium bis(oxalato)borate, lithium difluoro(bis(oxalato))phosphate, and lithium tetrafluoro(oxalato)phosphate.

In some embodiments, the solvent may be selected from at least one of ethylene carbonate, propylene carbonate, ethyl methyl carbonate, diethyl carbonate, dimethyl carbonate, dipropyl carbonate, methyl propyl carbonate, ethyl propyl carbonate, butylene carbonate, fluoroethylene carbonate, methyl formate, methyl acetate, ethyl acetate, propyl acetate, methyl propionate, ethyl propionate, propyl propionate, methyl butyrate, ethyl butyrate, 1,4-butyrolactone, sulfolane, dimethyl sulfone, methyl ethyl sulfone, and diethyl sulfone. The solvent may also be an ether solvent. The ether solvent may include one or more of ethylene glycol dimethyl ether, ethylene glycol diethyl ether, diethylene glycol dimethyl ether, triethylene glycol dimethyl ether, tetraethylene glycol dimethyl ether, 1,3-dioxolane, tetrahydrofuran, methyltetrahydrofuran, diphenyl ether, and crown ether.

In some embodiments, the electrolyte may optionally include additives. For example, additives may include negative electrode film-forming additives, positive electrode film-forming additives, and additives that improve certain performance of the battery cell, such as additives that improve overcharge/fast-charging performance, high-temperature performance of the battery cell, or low-temperature performance of the battery cell.

The gel electrolyte includes a polymer as a backbone network and may be used in combination with ionic liquid-lithium salt.

The solid-state electrolyte includes polymer solid-state electrolyte, inorganic solid-state electrolyte, and composite solid-state electrolyte.

As an example, the polymer of the polymer solid-state electrolyte may include polyether polyethylene oxide, polysiloxane, polycarbonate, polyacrylonitrile, polyvinylidene fluoride, polymethyl methacrylate, single-ion polymer, polyionic liquid, cellulose, or the like.

As an example, the inorganic solid-state electrolyte may be oxide solid electrolyte (crystalline perovskite, sodium superionic conductor, garnet, amorphous LiPON film), or sulfide solid electrolyte (one or more of crystalline lithium superionic conductor lithium germanium phosphorus sulfide, argyrodite, amorphous sulfide, halide solid electrolyte, nitride solid electrolyte, and hydride solid electrolyte).

As an example, the composite solid-state electrolyte is formed by adding inorganic solid-state electrolyte fillers to the polymer solid-state electrolyte.

The electrode assembly may be a wound structure, a laminated structure, or a hybrid structure formed through winding and stacking.

In some embodiments, the electrode assembly is a wound structure. The positive electrode plate and the negative electrode plate are wound into a wound structure.

In some embodiments, the electrode assembly is a laminated structure.

As an example, a plurality of positive electrode plates and a plurality of negative electrode plates may be provided, and the plurality of positive electrode plates and the plurality of negative electrode plates are alternately stacked.

As an example, a plurality of positive electrode plates may be provided, and the negative electrode plate may be folded to form a plurality of stacked folding segments, with a positive electrode plate sandwiched between adjacent folding segments.

As an example, both the positive electrode plate and the negative electrode plate may be folded to form a plurality of stacked folding segments.

As an example, a plurality of separators may be provided, separately disposed between any adjacent positive electrode plates or negative electrode plates.

As an example, the separator may be continuously provided, disposed between any adjacent positive electrode plates or negative electrode plates by folding or winding.

In some embodiments, the shape of the electrode assembly may be cylindrical, flat, or prismatic, or the like.

In some embodiments, the electrode assembly is provided with tabs, which can conduct current from the electrode assembly. The tabs include a positive tab and a negative tab.

In some embodiments, the battery cell may include a housing. The housing may be a steel housing, aluminum housing, plastic housing (for example, polypropylene), or composite metal housing (for example, copper-aluminum composite housing). In some embodiments, the housing may be a sealed structure or a non-sealed structure.

As an example, the battery cell may be a cylindrical battery cell, a prismatic battery cell, or a battery cell of other shapes. Prismatic battery cells include square-shell battery cells, blade-shaped battery cells, and multi-prismatic battery cells (for example, multi-prismatic battery cells are hexagonal prismatic battery cells), with no particular restrictions in the present application.

In some embodiments, the housing includes an end cover and a shell, where the shell has an opening, and the end cover is provided over the opening. The shell may have one or more openings. One or more end covers may also be provided.

In some embodiments, at least one electrode terminal is provided on the housing, and the electrode terminal is electrically connected to the tab. The electrode terminal may be directly connected to the tab or indirectly connected to the tab through a current collector component. The electrode terminal may be provided on the end cover or on the shell.

In some embodiments, a pressure relief mechanism is provided on the housing. The pressure relief mechanism is used to discharge internal gas from the battery cell.

As an example, the pressure relief mechanism is actuated to release internal pressure or temperature when the internal pressure or temperature of the battery cell reaches a predetermined threshold. When the internal pressure or temperature of the battery cell reaches the predetermined threshold, the pressure relief mechanism performs an action, or a weak structure provided in the pressure relief mechanism is damaged, thereby forming an opening or channel for releasing internal pressure or temperature. The threshold varies depending on design requirements. The threshold may depend on the materials of one or more of the positive electrode plate, negative electrode plate, electrolyte, and separator in the battery cell.

As an example, the pressure relief mechanism may be integrally formed with the housing.

As an example, the pressure relief mechanism may also be separately provided and connected to the housing.

The term "actuation" mentioned in the present application refers to the pressure relief mechanism performing an action or being activated to a certain state, thereby allowing the internal pressure and temperature of the battery cell to be released. The actions performed by the pressure relief mechanism may include, but are not limited to, components of the pressure relief mechanism moving to form an exhaust channel, and at least a portion of the pressure relief mechanism being ruptured, shattered, torn, or opened. When the pressure relief mechanism is actuated, high-temperature and high-pressure substances inside the battery cell are discharged as emissions from the actuated portion. In this way, the battery cell can release pressure and temperature under controlled pressure or temperature conditions, thereby avoiding potentially more serious accidents.

In some embodiments, when the housing is a non-sealed structure, the pressure relief mechanism may be configured as a through hole for discharging gas from inside the battery cell.

The emissions from the battery cell mentioned in the present application include, but are not limited to, electrolyte, dissolved or fragmented positive and negative electrode plates, fragments of the separator, high-temperature and high-pressure gases generated by reactions, and flames.

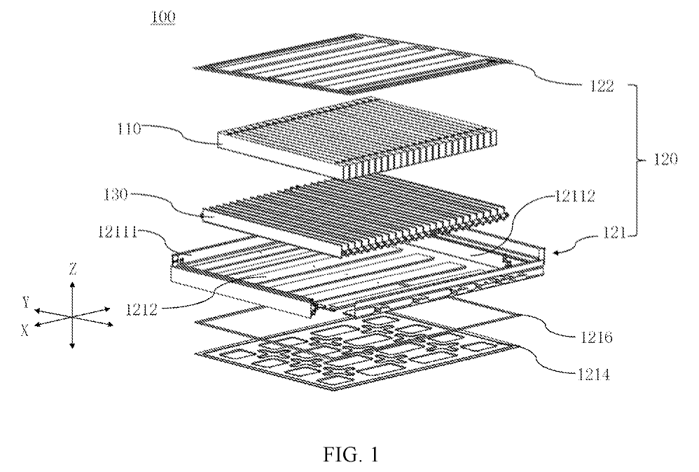

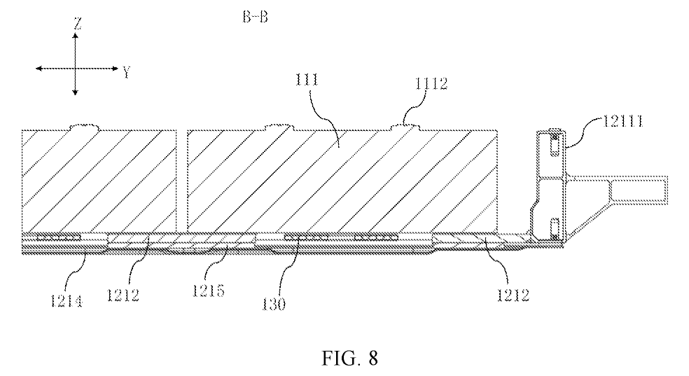

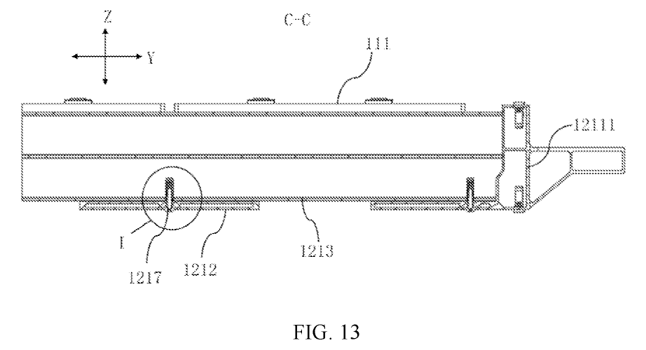

For convenience of explanation, the following embodiments refer to FIGS. 1–16, taking a battery apparatus 100 according to some embodiments of the present application as an example.

The battery apparatus 100 includes a battery cell assembly 110 and a box 120. The battery cell assembly 110 includes a plurality of battery cells 111 arranged along a first direction X. The box 120 includes a first box body 121 and a second box body 122, where the first box body 121 and the second box body 122 buckle each other and jointly define an accommodation space, the battery cell assembly 110 is located in the accommodation space, the first box body 121 includes a frame 1211 and a plurality of structural beams 1212, the structural beams 1212 are located at the bottom of the frame 1211 and connected to the frame 1211, the plurality of structural beams 1212 are spaced apart along a second direction Y, the first direction X and the second direction Y intersect, and a plane where the first direction X and the second direction Y are jointly located intersects a height direction Z of the box 120.

The structural beam 1212 may be a hollow beam or a solid beam. The material of the structural beam 1212 may be, but is not limited to, aluminum, aluminum alloy, steel, and other metals or non-metals, and can be specifically determined based on the actual application scenario of the battery apparatus 100. For example, when the battery apparatus 100 is applied in new energy vehicles, the material of the structural beam 1212 may be aluminum alloy.

One or more battery cell assemblies 110 may be provided, and each battery cell assembly 110 includes a plurality of battery cells 111. The battery cells 111 in the battery cell assembly 110 may be, but are not limited to, square battery cells and blade battery cells.

For example, one battery cell assembly 110 is provided, and the battery cells 111 are blade battery cells. Each blade battery cell may be connected to a plurality of structural beams 1212, and supported by the plurality of structural beams 1212.

The connection between the structural beam 1212 and the frame 1211 includes, but is not limited to, welding, riveting, and screw connection.

The same battery cell 111 may be supported by one, two, or more structural beams 1212. For example, one structural beam 1212 may be provided between two electrode terminals 1112 of the same battery cell 111.

In an optional example, one side of the second box body 122 facing the battery cell 111 has a protrusion extending along the first direction X, and the second box body 122 may form the protrusion by stamping, meaning that a groove is formed on the side of the protrusion away from the battery cell 111.

Spacing apart the plurality of structural beams 1212, compared with using a bottom plate or water-cooling plate placed on the largest surface of the cell as the bottom wall of the conventional box, reduces the weight of the box 120, thereby saving material costs

In some embodiments, the battery cell 111 is connected to the structural beam 1212.

The battery cell 111 may be fixed to both the structural beam 1212 and the second box body 122 by bonding or using a pressure strip.

For example, one side of the battery cell 111 facing the second box body 122 is provided with a pressure strip, the pressure strip is connected to the first box body 121 by screws, and the pressure strip is used to restrain the battery cell 111.

The battery cell 111 is connected to the structural beam 1212, which can increase the natural frequency of the battery apparatus 100, and in the case of vibration or swelling, can reduce the possibility of electrical connection failure of components inside the battery apparatus 100 to improve the reliability of the operation of the battery apparatus 100.

In some embodiments, the battery cell 111 is bonded to the structural beam 1212.

The battery cell 111 is bonded to the structural beam 1212, which can increase the natural frequency of the battery apparatus 100, so that in occasions with vibration impact or when the battery cell 111 swells, the possibility of electrical connection failure of components inside the battery apparatus 100 is reduced, thereby improving the reliability of the operation of the battery apparatus 100. This bonding, compared with the large-area glue filling at the bottom of the conventional box, can reduce the usage amount of structural glue, which is conducive to reducing the weight of the battery apparatus 100 and lowering the manufacturing cost.

In some embodiments, referring to FIGS. 1–3, the same battery cell 111 is bonded to a plurality of structural beams 1212.

In an example, the battery cell 111 is a blade battery cell, and each blade battery cell is bonded to all the structural beams 1212. At least two structural beams 1212 may be provided, specifically two. The two structural beams 1212 are connected, in one-to-one correspondence, to two first side beams 12111 spaced apart along the second direction Y of the frame 1211; specifically, the connection may be, but not limited to, welding and integral forming.

By jointly supporting the same battery cell 111 with a plurality of structural beams 1212, the stress generated by the charging and discharging swelling of the battery or the external vibration impact force can be evenly distributed to the plurality of structural beams 1212, reducing the excessive deformation of the structural beams 1212 caused by local stress concentration. The integrated structure formed by bonding the plurality of structural beams 1212 can significantly increase the natural frequency of the battery apparatus 100, and suppress the displacement of the battery cell 111 caused by vibration or the fatigue failure of electrical connection components such as tabs, which is conducive to improving the stability of the battery apparatus 100.

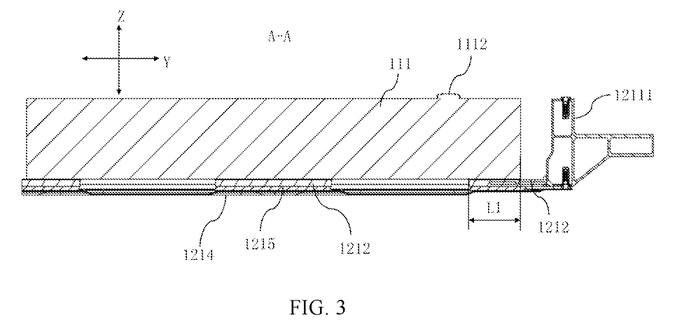

In some embodiments, referring to FIG. 3, along the height direction Z of the box 120, an orthographic projection area of a single structural beam 1212 on the same battery cell 111 is S1, and an area of a surface of the battery cell 111 facing one side of the structural beam 1212 is S2. The structural beam 1212 is a solid beam, and a value range of S2/S1 is 1.4–5; or the structural beam 1212 is a hollow beam, and a value range of S2/S1 is 1.4–2.5.

The value range of S2/S1 is limited to the above range, the box 120 is not too heavy, and on the premise of satisfying the support strength of the structural beam 1212, the natural frequency of the battery apparatus 100 is not too low, so that in occasions with vibration impact or when the battery cell 111 swells, the possibility of electrical connection failure of components inside the battery apparatus 100 is reduced, thereby improving the reliability of the operation of the battery apparatus 100.

In some embodiments, when the structural beam 1212 is a solid beam, a value range of S2/S1 is 1.6–3.3; or when the structural beam 1212 is a hollow beam, a value range of S2/S1 is 1.6–2.

The value range of S2/S1 is limited to the above range, which can further balance the requirements of weight and support strength, so that the natural frequency of the battery apparatus 100 is not too low.

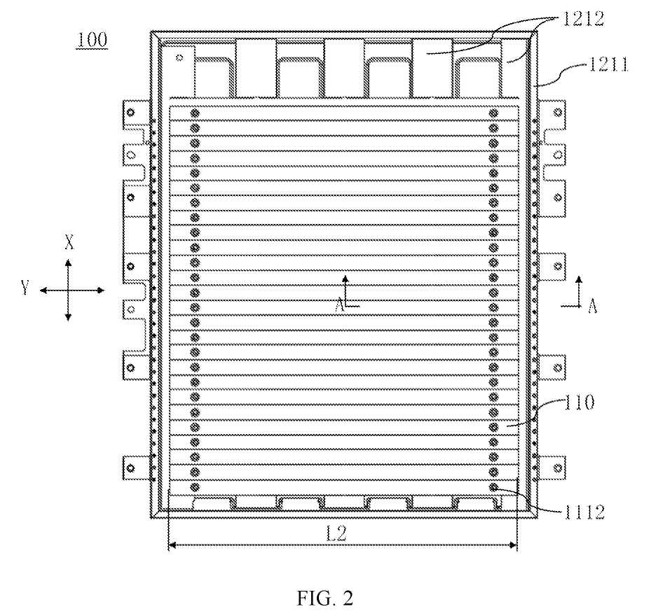

In some embodiments, referring to FIGS. 2 and 3, along the height direction Z of the box 120, a size of an orthographic projection of each structural beam 1212 on the same battery cell 111 along the second direction Y is L1, and a size of the battery cell 111 along the second direction Y is L2.

The structural beam 1212 is a solid beam, and a value range of L1/L2 is 0.2–0.7; or the structural beam 1212 is a hollow beam, and a value range of L1/L2 is 0.4–0.7.

In an example, regardless of whether the structural beam 1212 is a solid beam or a hollow beam, L1/L2 = 0.5, and along the second direction Y, in two adjacent structural beams 1212, the size of the portion of each structural beam 1212 bonded to the same battery cell 111 accounts for 1/2 of the size of the structural beam 1212.

The value range of L1/L2 is limited to the above range, which can not only make the battery cell 111 have sufficient contact area with the structural beam 1212 to disperse stress, but also reduce the situation where the weight of the box 120 increases due to excessive size.

In some embodiments, when the structural beam 1212 is a solid beam, a value range of L1/L2 is 0.3–0.6; or when the structural beam 1212 is a hollow beam, a value range of L1/L2 is 0.5–0.6.

The value range of L1/L2 is limited to the above range, further optimizing the value range, which can not only make the battery cell 111 have sufficient contact area with the structural beam 1212 to disperse stress, but also reduce the situation where the weight of the box 120 increases due to excessive size.

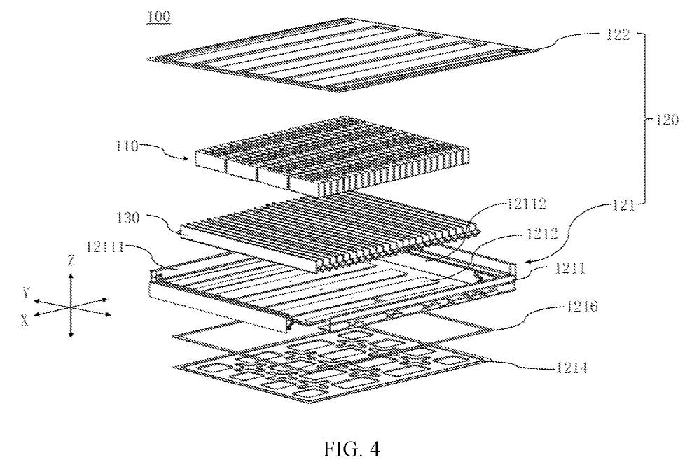

In some embodiments, referring to FIGS. 4–8, the same battery cell 111 is bonded to two adjacent structural beams 1212.

A portion of each structural beam 1212 is bonded to the battery cell 111 through structural glue, achieving bonding of two adjacent structural beams 1212 to the same battery cell 111.

This bonding, compared with support for the battery cell 111 by one structural beam 1212, can reduce the load on the structural beam 1212 to reduce the deformation of the structural beam 1212, and in occasions with vibration impact or when the battery cell 111 swells, reduce the possibility of electrical connection failure of components inside the battery apparatus 100, thereby improving the reliability of the operation of the battery apparatus 100.

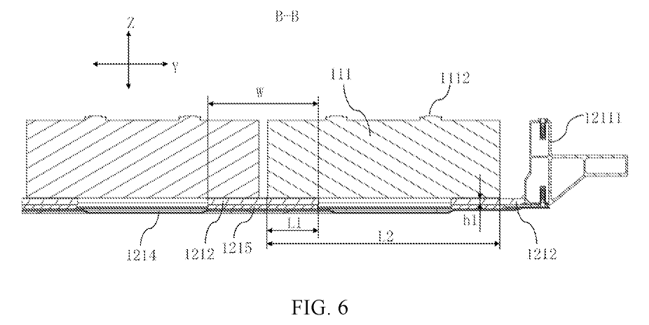

In some embodiments, referring to FIGS. 6–8, a plurality of battery cell assemblies 110 are provided, the plurality of battery cell assemblies 110 are arranged along the second direction Y, and two adjacent battery cell assemblies 110 are bonded to a same structural beam 1212.

The same structural beam 1212 can support two adjacent battery cell assemblies 110, so that the plurality of battery cell assemblies 110 are bonded to the plurality of structural beams 1212 through structural glue to form an integrated structure, which is conducive to increasing the natural frequency of the battery apparatus 100, and in occasions with vibration impact or when the battery cell 111 swells, the possibility of electrical connection failure of components inside the battery apparatus 100 is reduced, thereby improving the reliability of the operation of the battery apparatus 100. In addition, two adjacent battery cell assemblies 110 are jointly supported by one structural beam 1212, which can reduce the number of the structural beams 1212 used, and is conducive to reducing the weight of the box 120 of the battery apparatus 100.

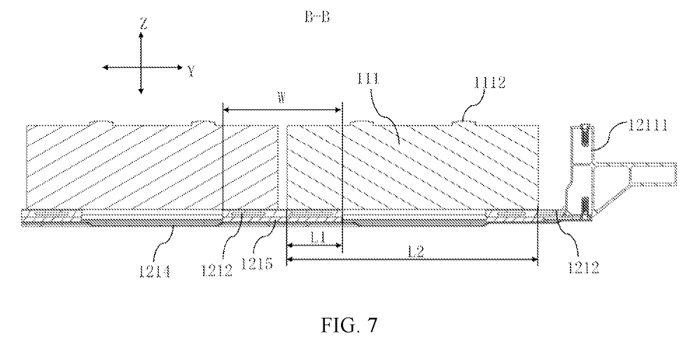

In some embodiments, referring to FIGS. 6 and 7, along the height direction Z of the box 120, an orthographic projection area of a single structural beam 1212 on the same battery cell 111 is S1, and an area of a surface of the battery cell 111 facing one side of the structural beam 1212 is S2. The structural beam 1212 is a solid beam, and a value range of S2/S1 is 2.8–10; or the structural beam 1212 is a hollow beam, and a value range of S2/S1 is 2.8–5.

When the structural beam 1212 is a solid beam, the value of S2/S1 may be 2.8, 3, 4, 5, 6, 7, 8, 9, 10, or any value within the range formed by any two of these values.

When the structural beam 1212 is a hollow beam, the value of S2/S1 may be, but is not limited to, 2.8, 3, 3.5, 4, 4.5, 5, and any value within the range formed by any two of these values.

When the structural beam 1212 is a hollow beam, the internal cavity of the structural beam 1212 may serve as a weight-reducing cavity or as a heat exchange flow channel 12121.

The value range of S2/S1 is limited to the above range, the box 120 is not too heavy, and on the premise of satisfying the support strength of the structural beam 1212, the natural frequency of the battery apparatus 100 is not too low, so that in occasions with vibration impact or when the battery cell 111 swells, the possibility of electrical connection failure of components inside the battery apparatus 100 is reduced, thereby improving the reliability of the operation of the battery apparatus 100.

In some embodiments, when the structural beam 1212 is a solid beam, a value range of S2/S1 is 3.3–6.6; or when the structural beam 1212 is a hollow beam, a value range of S2/S1 is 3.3–4.

The value range of S2/S1 is limited to the above range, which can further balance the requirements of weight and support strength, so that the natural frequency of the battery apparatus 100 is not too low.

In some embodiments, along the height direction Z of the box 120, a size of an orthographic projection of each structural beam 1212 on the same battery cell 111 along the second direction Y is L1, and a size of the battery cell 111 along the second direction Y is L2. The structural beam 1212 is a solid beam, and a value range of L1/L2 is 0.1–0.35; or the structural beam 1212 is a hollow beam, and a value range of L1/L2 is 0.2–0.35.

The value range of L1/L2 is limited to the above range, which can not only make the battery cell 111 have sufficient contact area with the structural beam 1212 to disperse stress, but also reduce the situation where the weight of the box 120 increases due to excessive size.

In some embodiments, when the structural beam 1212 is a solid beam, a value range of L1/L2 is 0.15–0.3; or when the structural beam 1212 is a hollow beam, a value range of L1/L2 is 0.25–0.3.

The value range of L1/L2 is limited to the above range, further optimizing the value range, which can not only make the battery cell 111 have sufficient contact area with the structural beam 1212 to disperse stress, but also reduce the situation where the weight of the box 120 increases due to excessive size.

In some embodiments, a size of the structural beam 1212 along the second direction Y is W. The structural beam 1212 is a solid beam, and a value range of W is 20 mm–700 mm; or the structural beam 1212 is a hollow beam, and a value range of W is 40 mm–700 mm.

For the solid beam or the hollow beam, the smaller lower limit can meet the support requirements of low-load scenarios while reducing material consumption, and the upper limit of 700 mm provides redundancy for high-load requirements. The wide beam can enhance the anti-vibration capability. For example, if the length and weight of a blade battery are relatively large, it can be supported by a relatively wide structural beam 1212 to maintain the stability of the overall structure of the battery apparatus 100.

The thermal management component 130 includes a heat exchange plate.

In an example, to reduce the weight of the box 120, the thermal management component 130 may use a lightweight plastic heat exchange plate. One or more thermal management components 130 may be provided between two adjacent structural beams 1212, with no specific limitation.

As a result, the temperature of each battery cell can be adjusted through the thermal management component 130, so that each battery cell 111 can fully exert its own performance during operation, to reduce the impact of excessively high or low temperature on the performance of the battery cell 111.

In some embodiments, referring to FIGS. 6–8, the structural beam 1212 is a flat beam, and a thickness direction of the structural beam 1212 is the same as the height direction Z of the box 120.

On the premise of not changing the total height of the box 120, the flat beam does not occupy too much space at the bottom of the box 120, so as to accommodate battery cells 111 with larger volume. On the premise of not changing the width of the structural beam 1212, the flat beam can reduce the weight of the box 120 and save more materials.

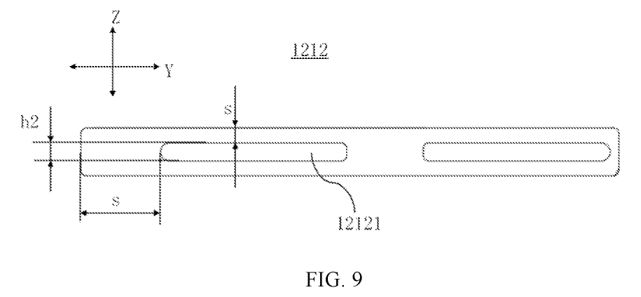

In some embodiments, referring to FIG. 6, the structural beam 1212 is a solid beam, and along the height direction Z of the box 120, a size of the structural beam 1212 is h1, and a value range of h1 may be, but is not limited to, 3 mm–8 mm. In some embodiments, referring to FIGS. 7 and 9, the structural beam 1212 is a hollow beam, and along the height direction Z of the box 120, a size of a cavity of the structural beam 1212 is h2, a wall thickness of the structural beam 1212 is s, a value range of h2 may be, but is not limited to, 4.4 mm–8 mm, and a value range of s may be, but is not limited to, 1.8 mm–3 mm.

When the structural beam 1212 is a hollow beam, the wall thickness of the structural beam 1212 includes the thickness of the wall of the cavity.

When the structural beam 1212 is a hollow beam, the wall thickness of the structural beam 1212 along the height direction Z of the box 120 and the wall thickness of the structural beam 1212 along the second direction Y may be equal or unequal.

As a result, on the premise of not changing the total height of the box 120, it does not occupy too much space at the bottom of the box 120, so as to accommodate battery cells 111 with larger volume. On the premise of not changing the width of the structural beam 1212, the weight of the box 120 can be reduced, and more materials can be saved.

In some embodiments, referring to FIGS. 7 and 9, the structural beam 1212 has a heat exchange flow channel 12121 inside.

Optionally, the heat exchange flow channel 12121 extends along the first direction X, and the heat exchange flow channel 12121 may be a bent flow channel or a straight flow channel.

One or more heat exchange flow channels 12121 may be provided in the structural beam 1212. When the structural beam 1212 is provided with a plurality of heat exchange flow channels 12121, the plurality of heat exchange flow channels 12121 may communicate through series or parallel connection. The heat exchange flow channels 12121 of two adjacent structural beams 1212 may communicate through series or parallel connection.

As the structural beam 1212 is provided with the heat exchange flow channel 12121 inside, the weight of the box 120 can be further reduced, and by introducing a heat exchange medium into the heat exchange flow channel 12121, the temperature of the battery cell 111 during operation can be adjusted, so that the battery apparatus 100 can operate in a suitable temperature range to fully exert the performance of the battery apparatus 100. In addition, the provision of the heat exchange flow channel 12121 in the structural beam 1212 can reduce the manufacturing difficulty compared with the use of a water-cooling plate for the conventional battery apparatus.

In some embodiments, referring to FIGS. 1 and 4, the battery apparatus 100 further includes a thermal management component 130, and along the first direction X, the thermal management component 130 is provided between two adjacent battery cells 111, the thermal management component 130 having a heat exchange channel inside.

The thermal management component 130 may be a heat exchange plate. When three or more battery cells 111 are provided in the battery cell assembly 110, two adjacent thermal management components 130 may communicate through series or parallel connection.

In an example, the heat exchange channel of the thermal management component 130 and the heat exchange flow channel 12121 of the structural beam 1212 may communicate through parallel or series connection, specifically through pipelines, or they may not be connected.

As a result, the temperature of each battery cell 111 can be adjusted through the thermal management component 130, so that each battery cell 111 can fully exert its own performance during operation, to reduce the impact of excessively high or low temperature on the performance of the battery cell 111. In other embodiments, the thermal management component 130 may not be provided between two adjacent battery cells 111, and only the cavity of the structural beam 1212 is used as a heat exchange flow channel.

In some embodiments, referring to FIGS. 1 and 4, the frame 1211 includes two first side beams 12111 spaced apart along the second direction Y, two outermost structural beams 1212 along the second direction Y are first structural beams, and the first structural beams are connected to the first side beams 12111.

The frame 1211 further includes second side beams 12112 spaced apart along the first direction X, and at least some of the structural beams 1212 may be connected to the second side beams 12112, specifically by welding.

The connection between the first structural beam and the first side beam 12111 includes, but is not limited to, welding, screw connection, and riveting.

The first side beams 12111 serve as lateral boundary supports of the frame 1211, which can increase the overall stiffness of the first box body 121 and reduce the risk of local deformation caused by uneven force. In occasions with vibration impact or when the battery cell 111 swells, the possibility of electrical connection failure of components inside the battery apparatus 100 can be reduced, thereby improving the reliability of the operation of the battery apparatus 100.

In some embodiments, the first structural beam is integrally formed with the first side beam 12111.

The first structural beam and the first side beam 12111 may be manufactured as an integrated structure through extrusion molding or welding.

As a result, the overall stiffness of the box 120 can be further improved, and the above connection method is simplified and improves the assembly efficiency compared with other connection methods such as use of fasteners between the first structural beam and the second side beam 12112.

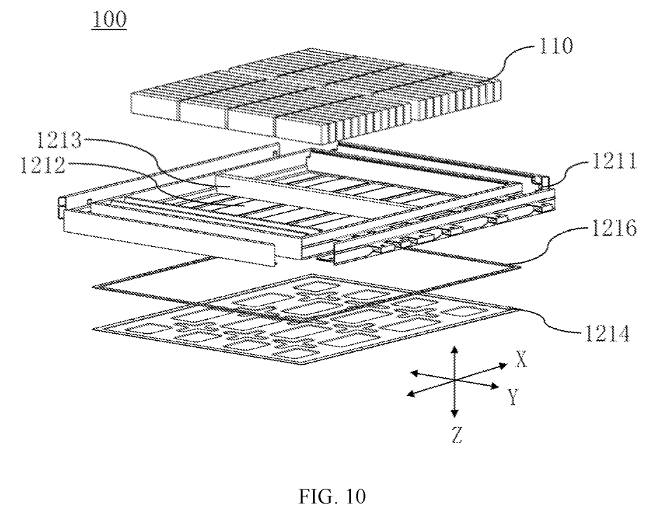

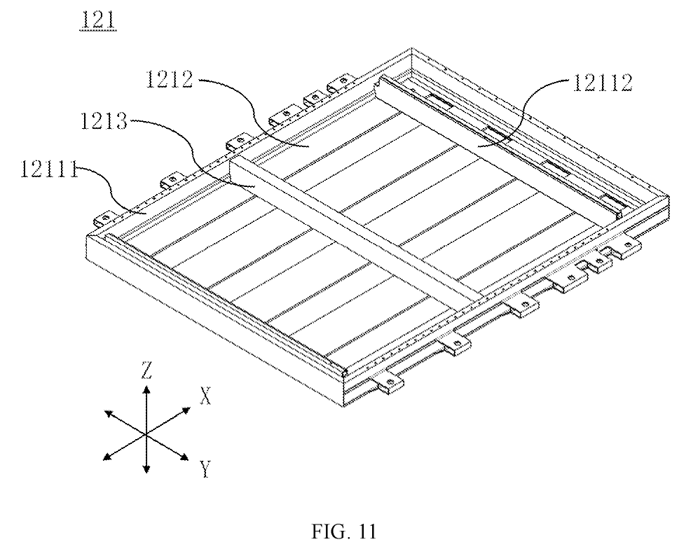

In some embodiments, referring to FIGS. 10 and 11, the first box body 121 further includes a spacer beam 1213, a length direction of the spacer beam 1213 is the same as the second direction Y, battery cell assemblies 110 are respectively provided on both sides of the spacer beam 1213 along the first direction X, and at least one of the structural beam 1212 and the frame 1211 is connected to the spacer beam 1213.

The spacer beam 1213 may be a solid beam or a hollow beam.

The connection between at least one of the structural beam 1212 and the frame 1211 and the spacer beam 1213 may include, but is not limited to, welding, screw connection, and riveting.

In an example, both ends of the spacer beam 1213 may be welded to different first side beams 12111.

The length direction of the spacer beam 1213 may be substantially perpendicular to the length direction of the structural beam 1212.

The provision of the spacer beam 1213 can further improve the bending resistance of the plurality of structural beams 1212 to increase the natural frequency of the battery apparatus 100, so that in occasions with vibration impact or when the battery cell 111 swells, the possibility of electrical connection failure of components inside the battery apparatus 100 is reduced, thereby improving the reliability of the operation of the battery apparatus 100.

In some embodiments, referring to FIGS. 11–13, the structural beam 1212 has a through hole 12122, the through hole 12122 runs through both sides of the structural beam 1212 along the height direction Z of the box 120, the first box body 121 further includes a locking member 1217, and one end of the locking member 1217 passes through the through hole 12122 and is connected to the spacer beam 1213.

The structural beam 1212 may be a solid beam or a hollow beam.

As a result, the fixation of the plurality of structural beams 1212 and the spacer beam 1213 can be achieved to increase the bearing capacity of the structural beams 1212, which is conducive to increasing the natural frequency of the battery apparatus 100.

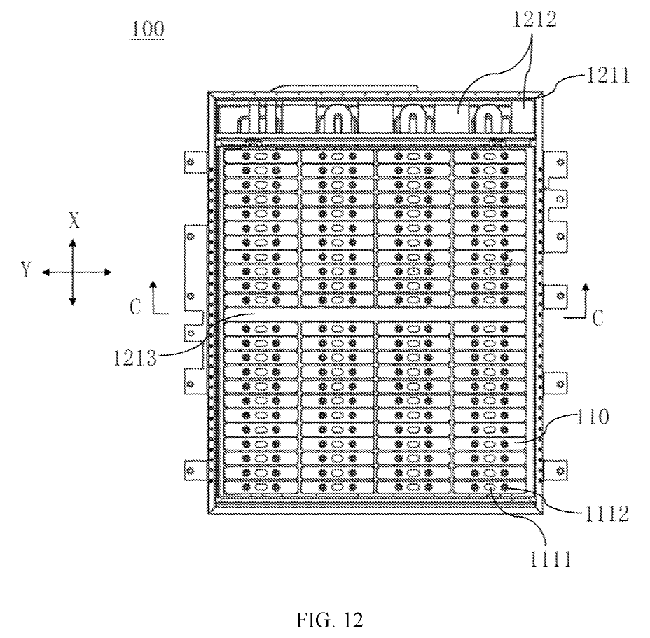

In some embodiments, referring to FIGS. 12–14, the structural beam 1212 has a cavity 12123 inside, and the through hole 12122 is provided in a side wall of one side of the cavity 12123 along the second direction Y.

One or more cavities 12123 may be provided. The cavity 12123 may serve as a weight-reducing cavity or as a heat exchange flow channel 12121. For example, when the cavity 12123 is used as a heat exchange flow channel, the cavity 12123 extends along the length direction of the structural beam 1212.

On the premise of satisfying the natural frequency of the battery apparatus 100, configuring the structural beam 1212 as a structure with the cavity 12123 can reduce the weight of the box 120 and save material costs. In addition, the cavity 12123 can also be used as a heat exchange channel to adjust the temperature of the battery cell 111 during operation.

In some embodiments, referring to FIGS. 12–14, a plurality of cavities 12123 are provided, the plurality of cavities 12123 are spaced apart along the second direction Y, and a side wall is formed between at least part of two adjacent cavities 12123.

As a result, the weight of the box 120 can be further reduced.

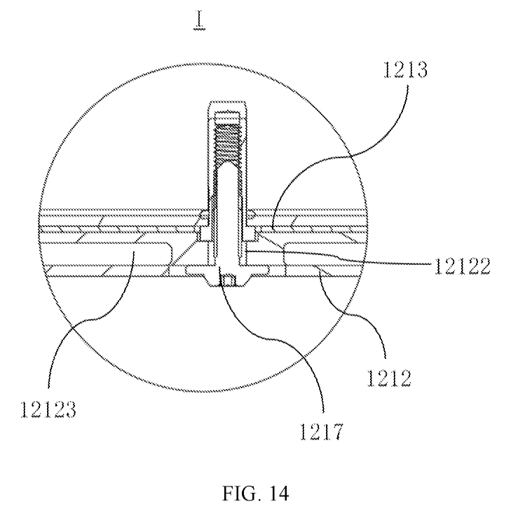

In some embodiments, referring to FIG. 14, along the height direction Z of the box 120, a size of an orthographic projection of the locking member 1217 on the structural beam 1212 along the second direction Y is less than or equal to a size of the side wall along the second direction Y.

The size of the orthographic projection of the locking member 1217 on the structural beam 1212 along the second direction Y is D1, and the size of the side wall along the second direction Y is D2, where D1 is less than or equal to D2, so that the side wall area is greater than or equal to the stressed surface area of the locking member 1217 on the structural beam 1212, to reduce the stress of the locking member 1217 on the structural beam 1212, thereby reducing the possibility of the cavity 12123 being crushed due to excessive pressure from the locking member 1217, and meeting the support stiffness and lightweight requirements of the structural beam 1212.

In some embodiments, referring to FIG. 3, one side of the battery cell 111 facing the second box body 122 is provided with an electrode terminal 1112.

As a result, it is convenient for the electrical connection between the electrode terminals 1112 of the battery cell 111 and the electrode terminals 1112 of other battery cells 111. In other examples, one side of the battery cell 111 away from the second box body 122 is provided with the electrode terminal 1112.

In some embodiments, one side of the battery cell 111 facing the second box body 122 is provided with a pressure relief mechanism 1111, and the pressure relief mechanism 1111 is configured to actuate when the battery cell 111 is in thermal runaway and an internal pressure of the battery cell 111 reaches a set value, to release emissions.

The pressure relief mechanism 1111 can effectively reduce the risk of internal pressure accumulation in the battery cell 111 and improve the safety of the battery apparatus 100.

In some embodiments, referring to FIGS. 1 and 4, the first box body 121 further includes a protective plate 1214, and the protective plate 1214 is located on a side of the first box body 121 away from the second box body 122 and connected to the first box body 121.

The connection between the protective plate 1214 and the first box body 121 includes screw connection, riveting, welding, or the like.

For example, the protective plate 1214 may be locked to the frame 1211 by screws.

The provision of the protective plate 1214 can protect the side of the first box body 121 away from the second box body 122. Especially when the battery apparatus 100 is applied to new energy vehicles, it can absorb external impact and collision.

In some embodiments, referring to FIGS. 6–8, along the height direction Z of the box 120, there is a gap between the protective plate 1214 and the structural beam 1212, and the first box body 121 further includes a buffer member 1215, the buffer member 1215 being provided in the gap.

Optionally, a side of the protective plate 1214 facing the structural beam 1212 may be provided with a receiving groove, and a gap is formed between the receiving groove and the structural beam 1212.

The buffer member 1215 may be made of foam, polyurethane, or fiber-reinforced thermoplastic material.

Providing the buffer member 1215 between the protective plate 1214 and the first box body 121 can buffer external impacts to improve the protection of the battery cell 111, thereby improving the reliability of the operation of the battery cell 111.

In some embodiments, referring to FIGS. 1 and 4, the first box body 121 further includes a sealing member 1216, the sealing member 1216 is arranged around the accommodation space, and the sealing member 1216 is sandwiched between the protective plate 1214 and the frame 1211.

The sealing member 1216 may be a sealing gasket, a sealing ring, a sealant, or the like.

The sealing member 1216 can prevent external dust, water, and the like from entering the battery apparatus 100 to protect the components inside the battery apparatus 100.

In some embodiments, referring to FIGS. 1 and 4, the first box body 121 is located below the second box body 122. The battery cell 111 is connected to both the structural beam 1212 and the second box body 122, and the electrode terminal 1112 of the battery cell 111 is disposed upside down in the box 120. The resulting structure, compared with a structure where the electrode terminal 1112 is disposed upright in the box 120, can improve the space utilization rate of the box 120.

In some embodiments, the structural beam 1212 is a solid beam, the structural beam 1212 includes a body portion and a reinforcing strip, the body portion has a receiving cavity extending along the length direction of the structural beam 1212, the receiving cavity runs through at least one end of the body portion, and the reinforcing strip is located in the receiving cavity and fits with the inner wall of the receiving cavity. The strength of the reinforcing strip is greater than the strength of the body portion. The cross-sectional shape of the reinforcing strip may be, but is not limited to, circular, square, and elliptical, which can improve the overall stiffness of the structural beam 1212 to reduce deformation of the structural beam 1212 under load.

In some embodiments, a size of the battery cell 111 along the second direction Y may be, but is not limited to, 200 mm–2000 mm.

The battery cell 111 may be a square-shell battery cell, a blade battery cell, or the like, with no specific limitation herein.

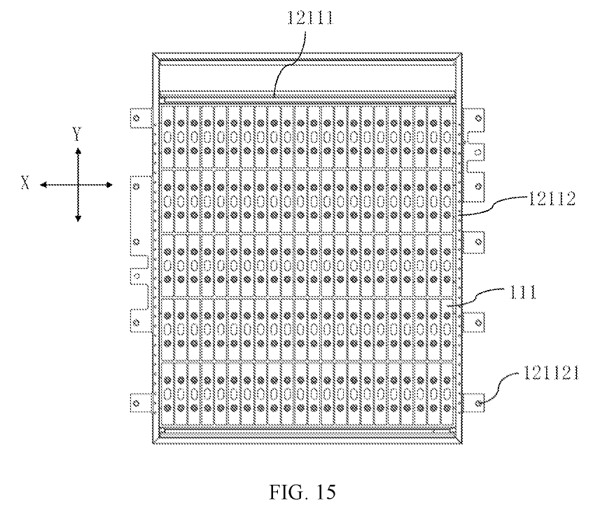

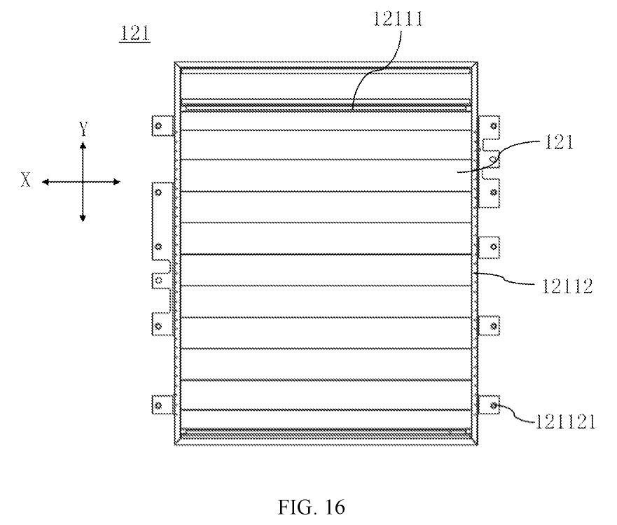

In some embodiments, referring to FIGS. 15 and 16, the frame 1211 includes two second side beams 12112 spaced apart along the first direction X, the structural beams 1212 are connected to the second side beams 12112, the second side beams 12112 are configured to be connected to a vehicle, and the first direction X is configured to intersect a traveling direction of the vehicle.

Exemplarily, the second side beam 12112 is provided with a mounting hole 121121, which can be connected to the vehicle through fasteners such as bolts passing through the mounting hole.

In FIGS. 15 and 16, the arrangement direction (the first direction X) of the plurality of battery cells 111 of the same battery cell assembly 110 is different from that in FIGS. 4 and 10. The second side beams 12112 in FIGS. 15 and 16 are used as mounting beams to fix the battery apparatus 100. The first side beams 12111 in FIGS. 2, 5, and 10 are used as mounting beams, and the second side beams 12112 in FIGS. 2, 5, and 10 are connected to the first side beams 12111 and used as swelling beams, meaning that they are capable of resisting the swelling force in the arrangement direction of the plurality of battery cells 111 of the same battery cell assembly 110 when the battery cells 111 swell.

The second side beams 12112 are configured to be connected to the vehicle, and the second side beams 12112 are used as mounting beams. Since the mounting beams have the characteristics of high strength and impact resistance, they can resist the swelling force of the battery cells 111 along the first direction X to reduce the deformation of the frame 1211. The structure formed by the second side beams, compared with the structure where the arrangement direction of the plurality of battery cells 111 of the same battery cell assembly 110 is the same as the traveling direction of the vehicle, can reduce the deformation of the frame without increasing the weight and strength of the side beams of the frame 1211 along the first direction X, which is conducive to reducing the weight of the first box body 121.

In some embodiments, referring to FIGS. 1, 18, and 19, the first box body 121 has a current collector channel 1218121, the structural beam 1212 has a heat exchange flow channel 12121 inside, and the heat exchange flow channels 12121 of two adjacent structural beams 1212 communicate through the current collector channel 1218121.

The heat exchange flow channels 12121 in the plurality of structural beams 1212 can be connected in series and/or parallel through the current collector channel 1218121.

The structural beam 1212 may be provided with one or more heat exchange flow channels 12121 The structures of the heat exchange flow channels 12121 of the plurality of structural beams 1212 may be the same or different. Exemplarily, the heat exchange flow channels 12121 in some of the structural beams 1212 may extend in a substantially U-shaped path, meaning that the heat exchange medium can flow along a U-shaped path. The heat exchange flow channel 12121 in the structural beam 1212 may also be a straight flow channel or a bent flow channel, and different structures of the heat exchange flow channels 12121 may be selected based on the series and/or parallel connection of the plurality of structural beams 1212.

The battery cell 111 has an electrode terminal 1112. In an example, one side of the battery cell 111 away from the second box body 122 is provided with an electrode terminal 1112, the electrode terminals 1112 are located between two adjacent structural beams 1212, and the electrode terminals 1112 are spaced apart from the structural beams 1212 along the second direction Y. Alternatively, one side of the battery cell 111 facing the second box body 122 is provided with the electrode terminal 1112. In another example, along the height direction Z of the box 120, both sides of the battery cell 111 are provided with electrode terminals 1112 respectively, where the electrode terminals 1112 on the side of the battery cell 111 away from the second box body 122 are located between two adjacent structural beams 1212 and are spaced apart from the structural beams 1212 along the second direction Y.

A heat exchange medium can be introduced into the current collector channel 1218121 to adjust the temperature of the battery cell 111. The heat exchange medium may be air, water, or other organic or inorganic solvents, such as oil.

The plurality of structural beams 1212 are spaced apart along the second direction Y. During welding, this arrangement, compared with the use of a water-cooling plate formed by combining a plurality of profile bottom plates and connected to the frame 1211 in the conventional battery apparatus 100, can reduce the welding area, improve production efficiency, lower manufacturing costs, reduce the weight of the box, and save material usage. In addition, the structural beam 1212 has a heat exchange flow channel 12121 inside, the first box body 121 has a current collector channel 1218121, and the heat exchange flow channels 12121 of two adjacent structural beams 1212 communicate through the current collector channel 1218121. The series or parallel connection between the heat exchange flow channels 12121 of two adjacent structural beams 1212 can be achieved based on requirements, allowing flexible design of the flow channels as needed. This reduces the structural complexity compared with the conventional use of a water-cooling plate for heat exchange with battery cells.

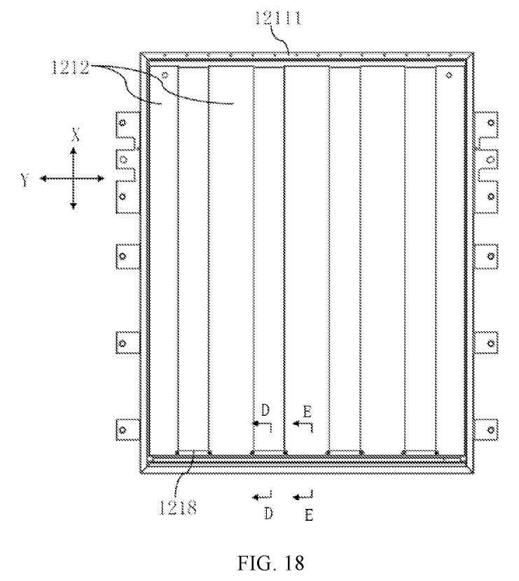

In some embodiments, referring to FIGS. 18–22, the first box body 121 includes a current collector component 1218, the frame 1211 includes two first side beams 12111 spaced apart along the first direction X, at least one end of the structural beam 1212 along the first direction X is connected to the current collector component 1218, the structural beam 1212 is connected to the first side beam 12111 through the current collector component 1218, the current collector component 1218 includes at least one current collector unit 12181, and the current collector unit 12181 has a current collector channel 1218121 inside.

One or more of current collector units 12181 may be provided, and the current collector unit 12181 may be provided with one or more of current collector channels 1218121.

The connection between two adjacent structural beams 1212 and the current collector unit 12181 includes, but is not limited to, welding, bonding, and integral forming.

The connection between the current collector component 1218 and the first side beam 12111 includes, but is not limited to, welding and bonding.

The structural beam 1212 is connected to the first side beam 12111 through the current collector component 1218. During assembly, the current collector component 1218 may be first connected to the first side beam 12111, and then the structural beam 1212 may be connected to the current collector component 1218, enabling segmented assembly for convenient installation. In addition, configuring the current collector component 1218 as a separate component facilitates the fabrication of the current collector channel 1218121.

In some embodiments, the structural beam 1212 and the current collector component 1218 are welded; and/or, the frame 1211 and the current collector component 1218 are welded.

In an example, welding both the structural beam 1212 and the frame 1211 to the current collector component 1218 may be performed using friction welding, laser welding, or the like.

By directly welding the structural beam 1212 to the current collector component 1218, the complex flow channel connection structures required in conventional profile bottom plate splicing are eliminated, significantly reducing the number of welds and the welding area, and reducing the possibility of leakage due to a plurality of welds in conventional profile splicing, thereby improving sealing performance. In addition, the welding of the structural beam 1212 to the frame 1211 through the current collector component 1218 forms a rigid connection, enhancing the overall vibration and impact resistance of the box 120, which is conducive to increasing the natural frequency of the battery apparatus 100.

In some embodiments, the current collector component 1218 further includes a connecting portion 12182, and both ends of the current collector unit 12181 along the second direction Y are connected to the connecting portion 12182. The end of the structural beam 1212 along the first direction X is welded to the connecting portion 12182; and/or, the first side beam 12111 and the connecting portion 12182 are welded.

In an example, the current collector unit 12181 is welded to two adjacent structural beams 1212.

The connection between the connecting portion 12182 and the current collector unit 12181 includes, but is not limited to, bonding, welding, and integral forming.

In an example, the connecting portion 12182 is a strip structure extending along the second direction Y.

The connecting portion 12182 serves as an intermediate transition component between the structural beam 1212 and the frame 1211, and the connecting portion 12182 serving as the intermediate transition component for welding to the structural beam 1212 and/or the first side beam 12111 facilitates the manufacturing of the first box body.

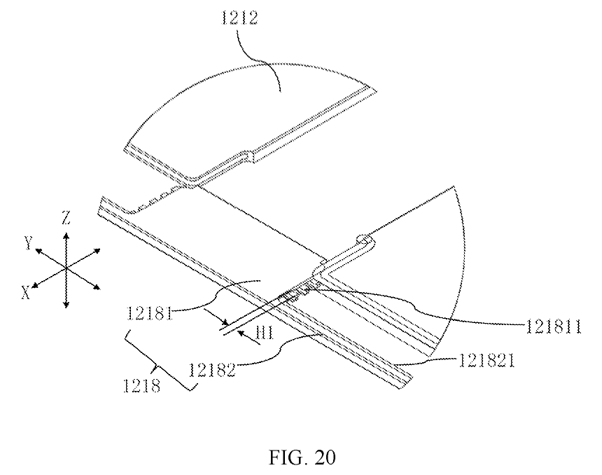

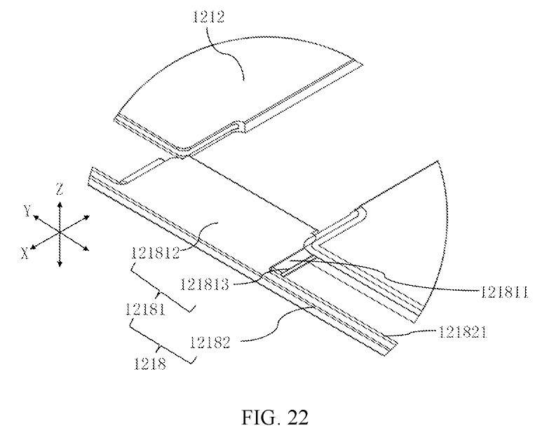

In some embodiments, referring to FIGS. 20 and 22, the current collector component 1218 further includes a plug-in portion 121811, both ends of the current collector unit 12181 along the second direction Y are each provided with a plug-in portion 121811, along the second direction Y, the plug-in portion 121811 at one end of the current collector unit 12181 is a first plug-in portion, the plug-in portion 121811 at the other end of the current collector unit 12181 is a second plug-in portion, the first plug-in portion is inserted into the heat exchange flow channel 12121 of one of two adjacent structural beams 1212, and the second plug-in portion is inserted into the heat exchange flow channel 12121 of the other of the two adjacent structural beams 1212.

In some examples, the plug-in portion 121811 may be a hollow annular structure or a solid plug-in strip.

The plug-in portion 121811 and the current collector unit 12181 may be integrally formed or fixed by welding or screw connection.

The plug-in portion 121811, after being inserted into the heat exchange flow channel 12121, forms an internal support structure, and the current collector unit 12181 can be welded to the structural beam 1212 by friction welding. Under the pressure of friction welding, the plug-in portion 121811 can reduce the possibility of plastic deformation or collapse of the thin-walled heat exchange flow channel 12121 due to extrusion, achieving good sealing performance during friction welding while reducing the possibility of the heat exchange flow channel 12121 being crushed. After welding, the heat exchange flow channel 12121 and the current collector channel 1218121 communicate more smoothly. In addition, since the structural beam 1212 bears the weight of the battery cell 111, the plug-in portion 121811 can distribute part of the stress, to reduce the stress at the weld between the current collector unit 12181 and the structural beam 1212, thereby reducing the possibility of the structural beam 1212 fracturing at the weld position due to excessive force, and improving the reliability of the structural beam 1212 at the connection position with the current collector component 1218.

In some embodiments, referring to FIG. 20, along the second direction Y, a depth of the plug-in portion 121811 inserted into the heat exchange flow channel 12121 is H1, and a value range of H1 is 5 mm–10 mm.

By setting the insertion depth of 5–10 mm, the plug-in portion 121811 can provide sufficient support force during friction welding to distribute stress during the welding process while avoiding excessive material waste to save manufacturing costs. In addition, when the structural beam 1212 bears the gravity from the battery cell 111 or when the battery apparatus 100 is in a vibrating environment, limiting H1 to the above range can distribute stress, reducing the possibility of the structural beam 1212 fracturing at the weld position due to excessive force, thereby improving the reliability of the structural beam 1212 at the connection position with the current collector component 1218.

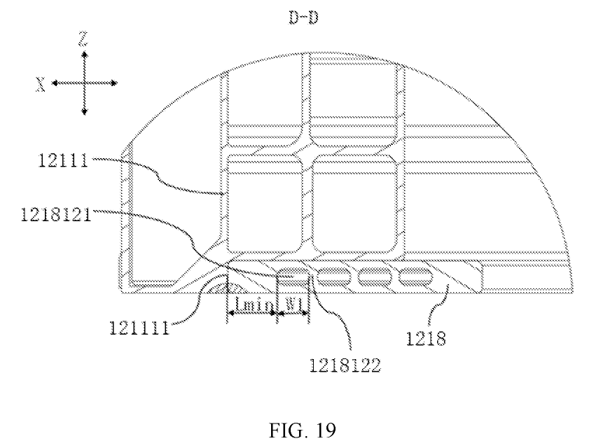

In some embodiments, referring to FIG. 19 a plurality of current collector channels 1218121 are provided, the plurality of current collector channels 1218121 are spaced apart along the second direction Y, a support rib 1218122 is formed between two adjacent current collector channels 1218121, the support rib 1218122 extends from both ends of the current collector channel 1218121 along the second direction Y, and a portion of the support rib 1218122 extending from the end of the current collector channel 1218121 along the second direction Y is configured as the plug-in portion 121811.

One or more of support ribs 1218122 may be provided at the same end of the current collector channel 1218121 along the second direction Y.

When a plurality of support ribs 1218122 are provided at the same end of the current collector channel 1218121 along the second direction Y, stress during friction welding can be better distributed, reducing the possibility of the current collector channel 1218121 being crushed and blocked.

The provision of the support rib 1218122 can reduce the possibility of the current collector channel 1218121 being crushed during friction welding, ensuring smooth communication between the current collector channel 1218121 and the heat exchange flow channel 12121 after welding, thereby improving welding quality.

In some embodiments, referring to FIG. 19, a size of the current collector channel 1218121 along the first direction X is W1, and a value range of W1 is 4 mm–10 mm.

As a result, when the current collector unit 12181 is friction welded to the frame 1211, the possibility of the current collector channel 1218121 being crushed due to excessive friction welding pressure can be reduced, improving welding quality to ensure smooth communication between the current collector channel 1218121 and the heat exchange flow channel 12121 after welding.

In some embodiments, referring to FIG. 22, the current collector unit 12181 includes a body portion 121812 and a tube portion 121813, the body portion 121812 has a receiving cavity inside, the receiving cavity runs through both ends of the body portion 121812 along the second direction Y, the tube portion 121813 is located in the receiving cavity, both ends of the tube portion 121813 extend from both ends of the body portion 121812 along the second direction Y, a portion of the tube portion 121813 extending from the body portion 121812 is configured as the plug-in portion 121811, the tube portion 121813 has a current collector channel 1218121 inside, and the current collector channel 1218121 runs through both ends of the tube portion 121813.

In this embodiment, both the body portion 121812 and the tube portion 121813 may be made of the same non-metal or metal material, or they may be made of different materials.

During friction welding, the tube portion 121813 can provide support for the heat exchange flow channel 12121, reducing the possibility of the current collector channel 1218121 being crushed.

In some embodiments, the strength of the tube portion 121813 is greater than the strength of the body portion 121812.

The tube portion 121813 and the body portion 121812 may be made of two different materials, metal or non-metal. For example, the body portion 121812 is made of a metal material, and the tube portion 121813 is made of a non-metal material or a metal material. Specifically, the body portion 121812 may be made of aluminum alloy, and the tube portion 121813 may be made of flat steel tubing, with the tube portion 121813 fixed to the receiving cavity by interference fit.

The strength of the tube portion 121813 being greater than that of the body portion 121812 can reduce the possibility of the current collector channel 1218121 being crushed during friction welding. Additionally, due to the high strength of the tube portion 121813, the flow area of the current collector channel 1218121 can be made greater to reduce the flow resistance of the heat exchange medium.

In some embodiments, referring to FIG. 20, the current collector component 1218 further includes a connecting portion 12182, both ends of the current collector unit 12181 along the second direction Y are connected to the connecting portion 12182, and the connecting portion 12182 is connected to both the end of the structural beam 1212 and the frame 1211.

The current collector unit 12181 and the connecting portion 12182 may be integrally formed or fixed by welding.

The connecting portion 12182 serves as an intermediate transition component between the structural beam 1212 and the frame 1211, allowing the connecting portion 12182 to be connected to the frame 1211 first, followed by the connection of the connecting portion 12182 to the structural beam 1212, thus enabling segmented assembly for convenient operation.

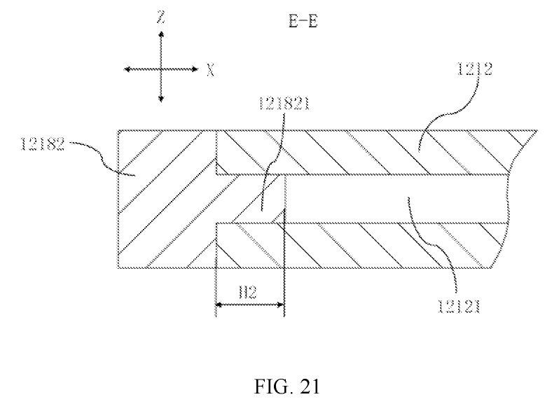

In some embodiments, referring to FIGS. 20 and 21, a side of the connecting portion 12182 facing the structural beam 1212 is provided with a protrusion 121821, and the protrusion 121821 is inserted into the heat exchange flow channel 12121.

The cross-sectional shape of the protrusion 121821 may be, but is not limited to, square, U-shaped, and hemispherical, and the cross-section of the protrusion 121821 is perpendicular to the second direction Y.

The protrusion 121821, after being inserted into the heat exchange flow channel 12121, forms a support structure, and the current collector component 1218 can be welded to the structural beam 1212 by friction welding. Under the pressure of friction welding, the protrusion 121821 can reduce the possibility of plastic deformation or collapse of the thin-walled heat exchange flow channel 12121 due to extrusion, achieving good sealing performance during friction welding while reducing the possibility of the heat exchange flow channel 12121 being crushed. After welding, the heat exchange flow channel 12121 and the current collector channel 1218121 communicate more smoothly. In addition, since the structural beam 1212 bears the weight of the battery cell 111, the protrusion 121821 can distribute part of the stress, reducing the stress at the weld between the current collector unit 12181 and the structural beam 1212, thereby reducing the possibility of the structural beam 1212 fracturing at the weld position due to excessive force, and improving the reliability of the structural beam 1212 at the connection position with the current collector component 1218.

In some embodiments, referring to FIG. 21, a size of the protrusion 121821 along the first direction X is H2, and a value range of H2 is 5 mm–10 mm.

By setting H2 within the above range, the protrusion 121821 can provide sufficient support force during friction welding to distribute stress during the welding process while avoiding excessive material waste to save manufacturing costs. In addition, when the structural beam 1212 bears the gravity from the battery cell 111 or when the battery apparatus 100 is in a vibrating environment, limiting H2 to the above range can distribute stress, reducing the possibility of the structural beam 1212 fracturing at the weld position due to excessive force, thereby improving the reliability of the structural beam 1212 at the connection position with the current collector component 1218.

In some embodiments, referring to FIG. 18, a plurality of current collector units 12181 are provided, two adjacent current collector units 12181 are spaced apart along the second direction Y, and two adjacent current collector units 12181 are connected through the connecting portion 12182.

Specifically, the number of the current collector units 12181 is N, and the number of the structural beams 1212 may be N+1, where N is an integer greater than 2.

Compared with the method where each current collector unit 12181 is individually connected to the frame 1211, integrating a plurality of current collector units 12181 into a single component requires only connecting the single component to the frame 1211 and then connecting the current collector units 12181 to the structural beams 1212 one by one, saving the time required for individual mounting of a plurality of current collector units 12181 to the frame 1211, and improving assembly efficiency. At the same time, mounting deviations caused by individual mounting of the current collector units 12181 can be reduced.

In some embodiments, referring to FIG. 19, the frame 1211 includes a first side beam 12111, the first side beam 12111 is connected to the current collector component 1218, the first side beam 12111 has a first abutting surface 121111 abutting against the current collector component 1218 along the first direction X, and along the first direction X, a minimum distance between the heat exchange flow channel 12121 and the first abutting surface 121111 is Lmin, with a value range of Lmin being 5 mm–15 mm.

Optionally, the connection between the first side beam 12111 and the current collector component 1218 may be welding, specifically friction welding.

When the current collector component 1218 is friction welded to the frame 1211, setting Lmin within the above range can reduce the possibility of the heat exchange flow channel 12121 being crushed due to friction welding, improving welding quality.

In some embodiments, the frame 1211 includes two first side beams 12111 spaced apart along the first direction X, the structural beam 1212 is directly welded to the first side beam 12111, and at least one first side beam 12111 has a current collector channel 1218121 inside.

In an example, the first side beam 12111 has a cavity, and the cavity of the first side beam 12111 serves as the current collector channel 1218121.

Directly connecting the structural beam 1212 to the first side beam 12111 can reduce the welding area, lower manufacturing costs, improve the production efficiency of the battery apparatus 100, and reduce structural complexity, facilitating manufacturing.

In some embodiments, the heat exchange flow channels 12121 inside the plurality of structural beams 1212 communicate through series or parallel connection to form a heat exchange flow path, the heat exchange flow path has a first interface 12124 and a second interface 12125, one of the first interface 12124 and the second interface 12125 is configured to introduce a heat exchange medium, and the other of the first interface 12124 and the second interface 12125 is configured to discharge the heat exchange medium.

The first interface 12124 may be provided on one of the two outermost structural beams 1212 along the second direction Y, and the second interface 12125 may be provided on the other of the two outermost structural beams 1212 along the second direction Y. The first interface 12124 and the second interface 12125 may be located at the end of the structural beam 1212 away from the current collector component 1218.

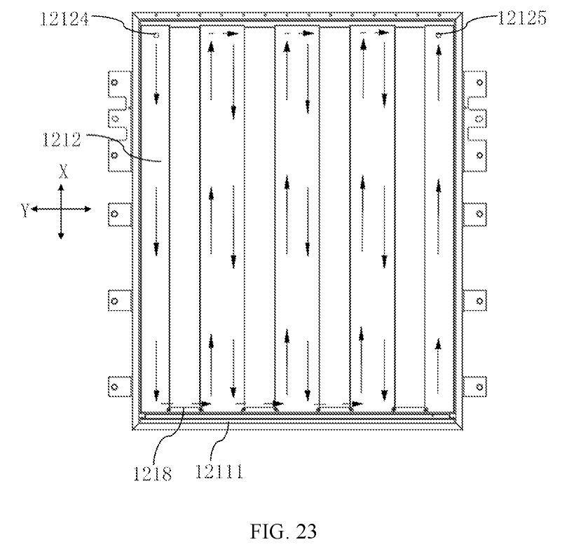

FIG. 23 is a structural diagram of the heat exchange flow channels 12121 inside the plurality of structural beams 1212 connected in series, with the direction of the arrows in FIG. 23 indicating the flow direction of the heat exchange medium in the heat exchange flow path. Along the second direction Y, the heat exchange medium flows from the outermost structural beam 1212 through the middle structural beam 1212 and finally flows out of the other outermost structural beam 1212.

The heat exchange flow channels 12121 inside the plurality of structural beams 1212 being in communication through series connection can, under constant flow rate, extend the heat exchange time, achieve more sufficient heat transfer, and have the characteristics of low resistance and low pressure drop. The heat exchange flow channels 12121 inside the plurality of structural beams 1212 connected in parallel can reduce pressure loss, and the synchronous cooling of parallel branches ensures consistent inlet temperatures for each branch of the heat exchange flow path, which is conducive to reducing temperature differences in different regions of the battery cell 111, making the temperatures of different battery cells 111 more uniform.

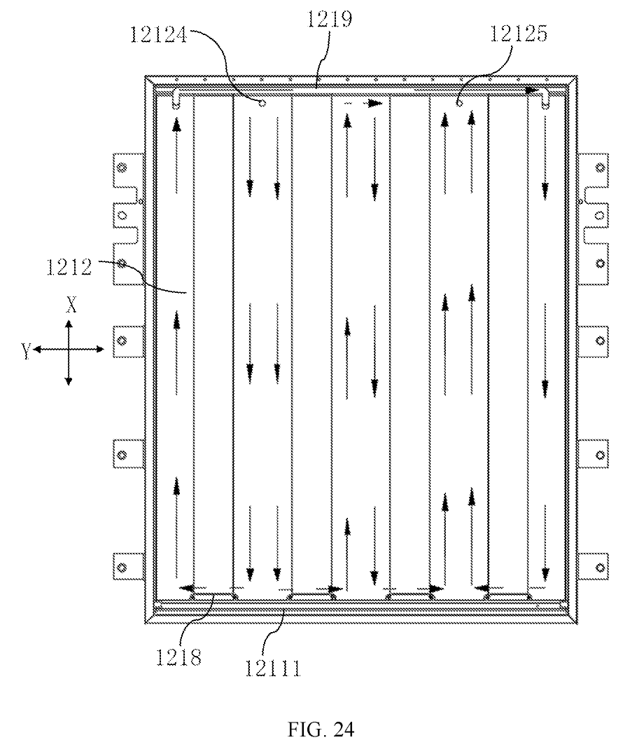

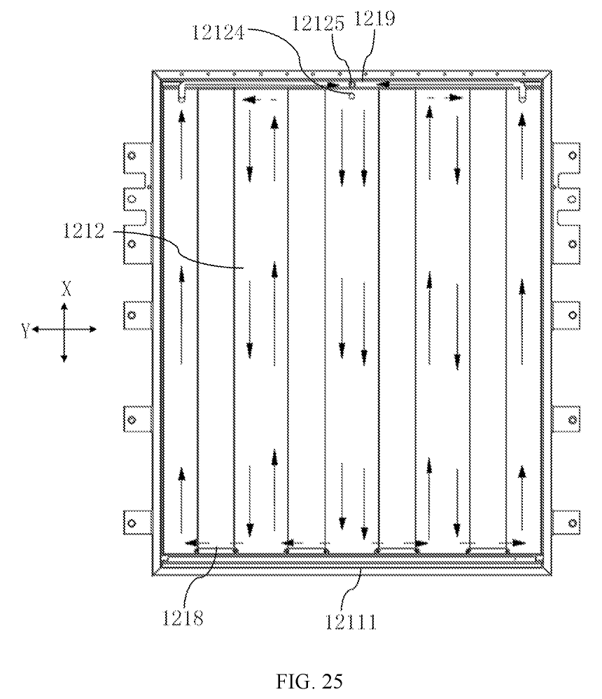

In some embodiments, referring to FIGS. 24 and 25, three or more structural beams 1212 are provided, the heat exchange flow channels 12121 inside the plurality of structural beams 1212 communicate through series and parallel connection to form a heat exchange flow path, the heat exchange flow path has a first interface 12124 and a second interface 12125, one of the first interface 12124 and the second interface 12125 is configured to introduce a heat exchange medium, and the other of the first interface 12124 and the second interface 12125 is configured to discharge the heat exchange medium.

Taking three structural beams 1212 as an example, the heat exchange flow channels 12121 of two structural beams 1212 communicate through series connection and then are connected in parallel with the heat exchange flow channel 12121 of another structural beam 1212, forming a hybrid flow path with both series and parallel connections.

Taking five structural beams 1212 as an example, the two outermost structural beams 1212 along the second direction Y communicate, specifically through a connecting tube 1219, and two structural beams 1212 adjacent to the two outermost structural beams 1212 are provided with a first interface 12124 and a second interface 12125, the first interface 12124 and the second interface 12125 being respectively located at the ends of the structural beams 1212 away from the current collector components 1218, with the flow direction of the heat exchange medium as indicated by the arrows in FIGS. 24 and 25.

The heat exchange flow channels 12121 inside the plurality of structural beams 1212 communicate through series and parallel connection, combining the advantages of series connection, which can extend the heat exchange time under constant flow rate for more sufficient heat transfer with low resistance and low pressure drop, and parallel connection, which can reduce pressure loss, with synchronous cooling of parallel branches ensuring consistent inlet temperatures for each branch of the heat exchange flow path, conducive to reducing temperature differences in different regions of the battery cell 111.

In some embodiments, referring to FIGS. 24 and 25, the first box body 121 further includes a connecting tube 1219, one of the two outermost structural beams 1212 along the second direction Y is a first one, the other of the two outermost structural beams 1212 along the second direction Y is a second one, and the heat exchange flow channel 12121 of the first one communicates with the heat exchange flow channel 12121 of the second one through the connecting tube 1219.

The heat exchange flow channel 12121 of the first one communicates with the heat exchange flow channel 12121 of the second one through the connecting tube 1219 in series, and the connecting tube 1219 may be provided at the end of the structural beam 1212 away from the current collector component 1218, reducing the possibility of interference after the battery cell 111 is mounted.

As a result, the provision of the connecting tube 1219 enables the layout of complex flow paths with series and parallel connections for the plurality of structural beams 1212, reducing structural complexity compared with conventional complex flow paths using water-cooling plates.

In some embodiments, referring to FIGS. 24 and 25, along the second direction Y, one of the structural beams 1212 between the two outermost structural beams 1212 and the connecting tube 1219 is provided with a first interface 12124, and another of the structural beams 1212 between the two outermost structural beams 1212 and the connecting tube 1219 is provided with a second interface 12125.

One or more structural beams 1212 may be provided between the two outermost structural beams 1212. For example, when two structural beams 1212 are provided between the two outermost structural beams 1212, one of the structural beams 1212 between the two outermost structural beams 1212 and the connecting tube 1219 is provided with the second interface 12125.

As a result, providing the first interface 12124 and the second interface 12125 in the structural beams 1212 and the connecting tube 1219 enables various different heat exchange flow paths to be adjusted according to the operating temperature of the battery apparatus 100, thereby achieving better heat exchange effects.

In some embodiments, referring to FIG. 25, the frame 1211 includes two first side beams 12111 spaced apart along the second direction Y, one of the plurality of structural beams 1212 is located at an intermediate position between the two first side beams 12111, and the structural beam 1212 located at the intermediate position between the two first side beams 12111 is provided with a first interface 12124.

The intermediate position between the two first side beams 12111 refers to a position equidistant from the two first side beams 12111 along the second direction Y.

During the operation of the battery apparatus 100, the temperature of the battery cell 111 corresponding to the structural beam 1212 in the intermediate region is more concentrated and higher. Through the above structure, the heat exchange medium can generally enter from the structural beam 1212 in the intermediate region, flow through the outermost structural beams 1212, and exit from the structural beam 1212 in the intermediate region, achieving more uniform heat exchange, reducing the overall temperature gradient, and improving overall heat dissipation.

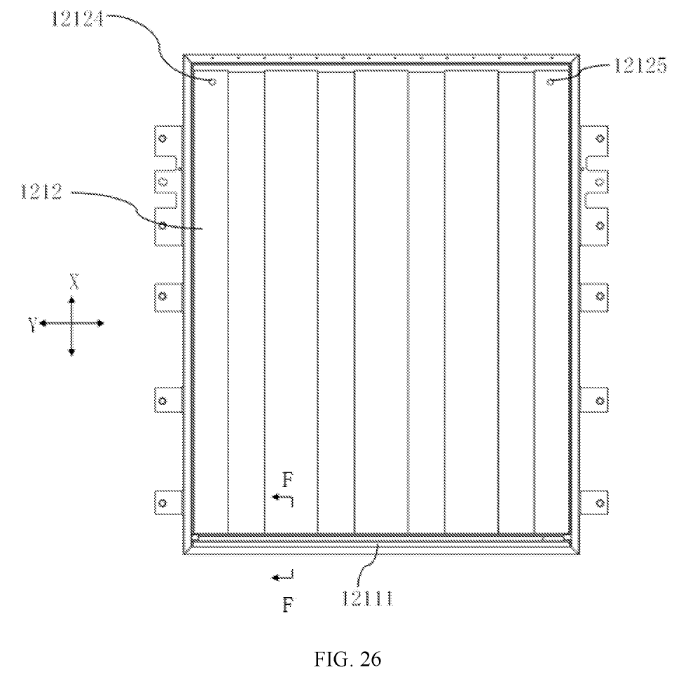

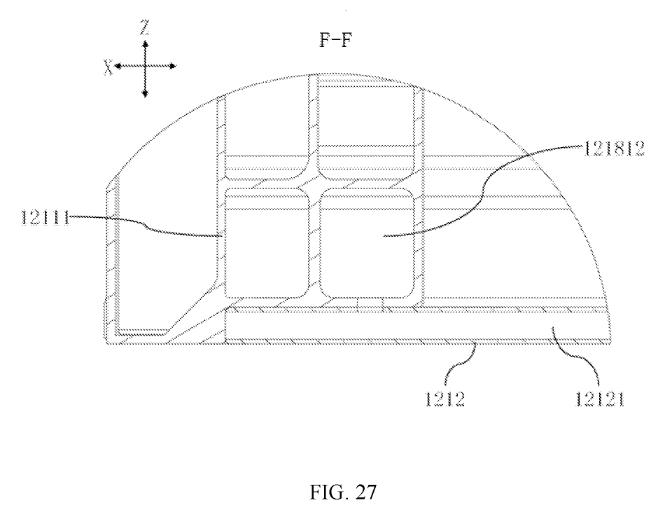

In some embodiments, referring to FIGS. 26 and 27, the frame 1211 includes two second side beams 12112 spaced apart along the first direction X, the structural beams 1212 are connected to the second side beams 12112, the second side beams 12112 are configured to be connected to a vehicle, and the first direction X is configured to intersect a traveling direction of the vehicle.

The second side beams 12112 are configured to be connected to the vehicle, and the second side beams 12112 are used as mounting beams. Since the mounting beams have the characteristics of high strength and impact resistance, they can resist the swelling force of the battery cells 111 along the first direction X to reduce the deformation of the frame 1211. The structure formed by the second side beams, compared with the structure where the arrangement direction of the plurality of battery cells 111 of the same battery cell assembly 110 is the same as the traveling direction of the vehicle, can reduce the deformation of the frame 1211 without increasing the weight and strength of the side beams of the frame 1211 along the first direction X, which is conducive to reducing the weight of the first box body 121.

For convenience of explanation, the following embodiments take an electric apparatus according to some embodiments of the present application as an example.

The electric apparatus includes the battery apparatus 100 of the above embodiments, and the battery apparatus 100 is configured to provide electrical energy to the electric apparatus.

The electric apparatus may include, but is not limited to, electric scooters, electric tools, vehicles, ships, and spacecraft, where spacecraft include airplanes, rockets, space shuttles, spaceships, and the like.

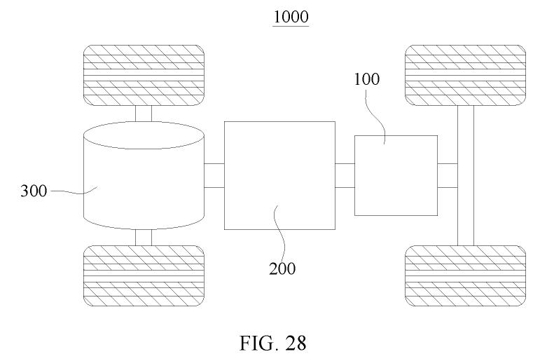

Referring to FIG. 28, FIG. 28 is a schematic structural diagram of a vehicle 1000 provided by some embodiments of the present application. The vehicle 1000 may be a fuel vehicle, a gas vehicle, or a new energy vehicle, and the new energy vehicle may be a pure electric vehicle, a hybrid vehicle, or an extended-range vehicle. A battery apparatus 100 is provided inside the vehicle 1000, and the battery apparatus 100 may be provided at the bottom, head, or tail of the vehicle 1000. The battery apparatus 100 may be used to supply power to the vehicle 1000. For example, the battery apparatus 100 may serve as an operating power source for the vehicle 1000. The vehicle 1000 may further include a controller 200 and a motor 300, and the controller 200 is configured to control the battery apparatus 100 to supply power to the motor 300, for example, for the working power requirements during the start, navigation, and driving of the vehicle 1000.

Since the electric apparatus includes all the technical features of the battery apparatus 100 of the above embodiments, the effects achieved are the same as those described above and will not be repeated here.

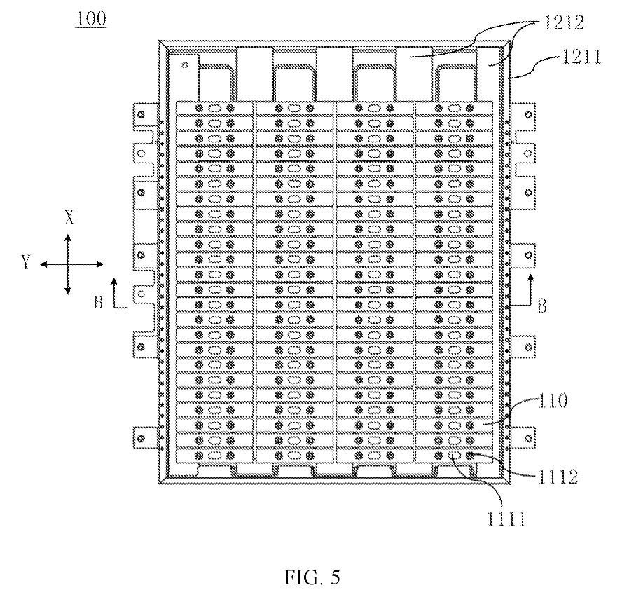

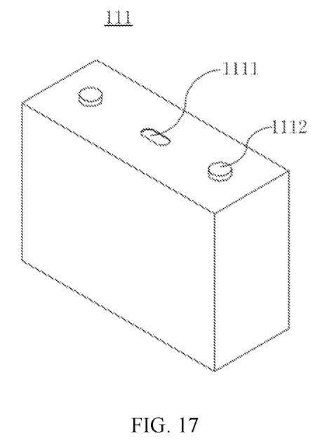

In an optional embodiment of the battery apparatus 100, referring to FIGS. 5, 7, and 17, the battery apparatus 100 includes a battery cell assembly 110 and a box 120. The battery cell assembly 110 includes a plurality of battery cells 111 arranged along a first direction X. The box 120 includes a first box body 121 and a second box body 122, the first box body 121 and the second box body 122 buckle each other and jointly define an accommodation space, the battery cell assembly 110 is located in the accommodation space, the first box body 121 includes a frame 1211, a protective plate 1214, a buffer member 1215, a sealing member 1216, and a plurality of structural beams 1212, the structural beams 1212 are located at the bottom of the frame 1211 and connected to the frame 1211, the plurality of structural beams 1212 are spaced apart along a second direction Y, the first direction X and the second direction Y intersect, and a plane where the first direction X and the second direction Y are jointly located intersects a height direction Z of the box 120. The same battery cell 111 is bonded to two adjacent structural beams 1212. A plurality of battery cell assemblies 110 are provided, the plurality of battery cell assemblies 110 are arranged along the second direction Y, and two adjacent battery cell assemblies 110 are bonded to a same structural beam 1212. The structural beam 1212 has a heat exchange flow channel 12121 inside as well as an inlet and an outlet both communicating with the heat exchange flow channel 12121, and the heat exchange flow channel 12121 extends along the first direction X. Along the height direction Z of the box 120, an orthographic projection area of a single structural beam 1212 on the same battery cell 111 is S1, an area of a surface of the battery cell 111 facing one side of the structural beam 1212 is S2, the structural beam 1212 is a hollow beam, and a value range of S2/S1 is 2.8–5. Along the height direction Z of the box 120, a size of an orthographic projection of each structural beam 1212 on the same battery cell 111 along the second direction Y is L1, a size of the battery cell 111 along the second direction Y is L2, and a value range of L1/L2 is 0.2–0.35. A size of the structural beam 1212 along the second direction Y is W, and a value range of W is 40 mm–700 mm. Along the height direction Z of the box 120, a size of the heat exchange flow channel 12121 (cavity) of the structural beam 1212 is h2, a wall thickness of the structural beam 1212 is s, a value range of h2 is 4.4 mm–8 mm, and a value range of s is 1.8 mm–3 mm. The protective plate 1214 is located on a side of the first box body 121 away from the second box body 122 and connected to the first box body 121. A buffer member 1215 is provided between the protective plate 1214 and the structural beam 1212. The sealing member 1216 is arranged around the accommodation space, and the sealing member 1216 is sandwiched between the protective plate 1214 and the frame 1211. The first box body 121 is located below the second box body 122.

The plurality of structural beams 1212 are spaced apart along the second direction Y, the structural beam 1212 is provided with the heat exchange flow channel 12121, the same structural beam 1212 can support two adjacent battery cell assemblies 110, and the values of S2/S1, L1/L2, W, and h2 are set within the above ranges. This can reduce the weight of the box 120 and reduce the usage of structural glue, reducing material costs, and increase the natural frequency of the battery apparatus 100, reducing the possibility of electrical connection failure of components inside the battery apparatus 100 in occasions with vibration impact or when the battery cell 111 swells, thereby improving the reliability of the operation of the battery apparatus 100.

Finally, it should be noted that the above embodiments are only used to illustrate the technical solutions of the present application, not to limit them. Although the present application has been described in detail with reference to the foregoing embodiments, those of ordinary skill in the art should understand that they can still modify the technical solutions recorded in the foregoing embodiments, or equivalently replace some or all of the technical features therein. These modifications or replacements do not make the essence of the corresponding technical solutions depart from the scope of the technical solutions of the embodiments of the present application, and they should all be covered in the scope of the claims and description of the present application. In particular, as long as there is no structural conflict, the various technical features mentioned in the embodiments can be combined in any way. The present application is not limited to the specific embodiments disclosed in the text, but includes all technical solutions falling within the scope of the claims.

What is claimed is:

1. A battery apparatus, comprising:
a battery cell assembly, comprising a plurality of battery cells arranged along a first direction; and
a box, comprising a first box body and a second box body, the first box body and the second box body jointly defining an accommodation space, the battery cell assembly being located in the accommodation space, the first box body comprising a frame and a plurality of structural beams, the structural beams being located at a bottom of the frame and connected to the frame, the plurality of structural beams being spaced apart along a second direction, the first direction and the second direction intersecting, and a plane where the first direction and the second direction are jointly located intersecting a height direction of the box.

2. The battery apparatus according to claim 1, wherein the battery cell is connected to the structural beam.

3. The battery apparatus according to claim 2, wherein the battery cell is bonded to the structural beam.

4. The battery apparatus according to claim 3, wherein a same battery cell is bonded to the plurality of structural beams.

5. The battery apparatus according to claim 4, wherein:
along the height direction of the box, an orthographic projection area of a single structural beam on the same battery cell is S1, and an area of a surface of the battery cell facing one side of the structural beam is S2; and
the structural beam is a solid beam, and a value range of S2/S1 is 1.4–5; or the structural beam is a hollow beam, and a value range of S2/S1 is 1.4–2.5.

6. The battery apparatus according to claim 5, wherein:
the structural beam is a solid beam, and the value range of S2/S1 is 1.6–3.3; or
the structural beam is a hollow beam, and the value range of S2/S1 is 1.6–2.

7. The battery apparatus according to claim 4, wherein:
one battery cell assembly is provided, and along the height direction of the box, a size of an orthographic projection of each structural beam on the same battery cell along the second direction is L1, and a size of the battery cell along the second direction is L2; and
the structural beam is a solid beam, and a value range of L1/L2 is 0.2–0.7; or the structural beam is a hollow beam, and a value range of L1/L2 is 0.4–0.7.

8. The battery apparatus according to claim 7, wherein:
the structural beam is a solid beam, and the value range of L1/L2 is 0.3–0.6; or
the structural beam is a hollow beam, and the value range of L1/L2 is 0.5–0.6.

9. The battery apparatus according to claim 4, wherein the same battery cell is bonded to two adjacent structural beams.

10. The battery apparatus according to claim 9, wherein a plurality of battery cell assemblies are provided, the plurality of battery cell assemblies are arranged along the second direction, and two adjacent battery cell assemblies are bonded to a same structural beam.

11. The battery apparatus according to claim 9, wherein:
along the height direction of the box, an orthographic projection area of a single structural beam on the same battery cell is S1, and an area of a surface of the battery cell facing one side of the structural beam is S2; and
the structural beam is a solid beam, and a value range of S2/S1 is 2.8–10; or the structural beam is a hollow beam, and a value range of S2/S1 is 2.8–5.

12. The battery apparatus according to claim 11, wherein:
the structural beam is a solid beam, and the value range of S2/S1 is 3.3–6.6; or
the structural beam is a hollow beam, and the value range of S2/S1 is 3.3–4.

13. The battery apparatus according to claim 10, wherein:
along the height direction of the box, a size of an orthographic projection of each structural beam on the same battery cell along the second direction is L1, and a size of the battery cell along the second direction is L2; and
the structural beam is a solid beam, and a value range of L1/L2 is 0.1–0.35; or the structural beam is a hollow beam, and a value range of L1/L2 is 0.2–0.35.

14. The battery apparatus according to claim 13, wherein:
the structural beam is a solid beam, and the value range of L1/L2 is 0.15–0.3; or
the structural beam is a hollow beam, and the value range of L1/L2 is 0.25–0.3.

15. The battery apparatus according to claim 1, further comprising:
a thermal management component, wherein the thermal management component is located on a side of the battery cell away from the second box body, and the thermal management component is provided between two adjacent structural beams, the thermal management component having a heat exchange channel.

16. The battery apparatus according to claim 1, wherein:
a size of the structural beam along the second direction is W; and
the structural beam is a solid beam, and a value range of W is 20 mm–700 mm; or the structural beam is a hollow beam, and a value range of W is 40 mm–700 mm.

17. The battery apparatus according to claim 1, wherein the structural beam is a flat beam, and a thickness direction of the structural beam is the same as the height direction of the box.

18. The battery apparatus according to claim 17, wherein:
the structural beam is a solid beam, and along the height direction of the box, a size of the structural beam is h1, and a value range of h1 is 3 mm–8 mm;
or, the structural beam is a hollow beam, and along the height direction of the box, a size of a cavity of the structural beam is h2, a wall thickness of the structural beam is s, a value range of h2 is 4.4 mm–8 mm, and a value range of s is 1.8 mm–3 mm.

19. The battery apparatus according to claim 1, wherein:
the structural beam has a heat exchange flow channel inside; and/or
the battery apparatus further comprises a thermal management component, and along the first direction, the thermal management component is provided between two adjacent battery cells, the thermal management component having a heat exchange channel inside.

20. An electric device, comprising the battery apparatus according to claim 1, the battery apparatus being configured to provide electrical energy to the electric device.
